(19) United States
(12) Patent Application Publication
(10) Pub. No.: US 2023/0405564 A1
(43) Pub. Date: Dec. 21, 2023

(54) CATALYST FOR ENHANCED HIGH TEMPERATURE CONVERSION AND REDUCED N2O MAKE

(71) Applicant: BASF Corporation, Florham park, NJ (US)

(72) Inventors: Matthias Peter, Hannover (DE); Tobias Guenter, Nienburg/Weser (DE); Burkhard Rabe, Nienburg/Weser (DE); Tobias Engels, Hannover (DE)

(21) Appl. No.: 18/033,895

(22) PCT Filed: Oct. 29, 2021
(86) PCT No.: PCT/EP2021/080128

§ 371 Date: Apr. 26, 2023

(30) Foreign Application Priority Data
Oct. 30, 2020 (EP) 20204846.8

(51) Int. Cl. B01J 29/76; B01J 23/745; B01J 23/72; B01J 35/04; B01J 37/02; B01J 37/03; B01J 37/08; B01D 53/94; F01N 3/28; F01N 3/10; F01N 3/035

(52) U.S. Cl. CPC B01J 29/763; B01J 23/745; B01J 23/72; B01J 35/04; B01J 37/0215; B01J 37/038; B01J 37/08; B01D 53/9413; F01N 3/2803; F01N 3/106; F01N 3/035; B01J 2229/186; B01D 2255/50; B01D 2251/2067; B01D 2255/20738; B01D 2255/20761; B01D 2257/404; B01D 2258/012; F01N 2370/04; F01N 2510/068

(57) ABSTRACT

The present invention relates to a catalyst for the treatment of an exhaust gas of a diesel combustion engine, said catalyst particularly comprising a specific substrate and a coating disposed on the surface of the internal walls of said substrate, the coating particularly comprising a specific first non-zeolitic oxidic material, and a specific zeolitic material comprising Fe and Cu, wherein the catalyst exhibits a weight ratio of Fe, calculated as Fe₂O₃, relative to Cu, calculated as CuO, Fe₂O₃:CuO, of less than 0.1:1. Further, the present invention relates to a specific process for preparing said catalyst. Yet further, the present invention relates to a system comprising said catalyst and to a use thereof.

### TECHNICAL FIELD

The present invention relates to a process for preparing a catalyst which is suitable for the treatment of an exhaust gas of a diesel combustion engine. Further, the present invention relates to a catalyst which can be prepared according to said process and a use thereof.

### INTRODUCTION

Cu-containing zeolitic materials, in particular zeolitic materials having framework structure type CHA, are currently used for automotive light duty diesel-selective catalytic reduction (LDD-SCR) catalysts since they are able to remove NOx emissions from an exhaust stream at very low temperatures. However, such catalysts typically show a comparatively high N₂O make at temperatures higher than 300° C. and a poorer NOₓ conversion at temperatures higher than 500° C. Thus, those Cu-containing zeolites which achieve best results at low temperatures are typically poor in NOx conversion at high temperatures, in particular compared to Fe-Beta zeolites. An approach to solve said deficiency by doping a zeolitic material having framework structure type CHA, in particular chabazites, with Fe, usually leads to a catalyst bearing a strong loss in low temperature conversion although the high temperature conversion can often be improved.

In upcoming legislations, in particular Euro 7 and 8 LDD-legislations, N₂O emission limits will be implemented or the strong greenhouse gas N₂O will be counted as CO₂ equivalent. Accordingly, the need exists to provide a catalyst, in particular a SCR catalyst, showing strongly reduced N₂O make while exhibiting an improved high temperature conversion.

WO 2017/134581 A1 relates to a copper and iron exchanged chabazite catalyst. It is disclosed that such a catalyst can be prepared by contacting a chabazite with a copper metal precursor and an iron metal precursor. WO 2020/063360 A1 discloses a method for preparing a molecular sieve SCR catalyst, wherein the molecular sieve can comprise Fe and Cu. CN 104607239 A relates a method for preparing a copper and iron composite SCR catalyst. US 2015/0290632 A1 relates to an iron and copper-containing chabazite zeolite catalyst for use in NOx reduction. WO 2012/075400 A1 discloses a catalyst composition comprising a zeolite material having a CHA framework structure and an extra-framework promoter metal disposed thereon which is selected from copper, iron, and mixtures thereof. WO 2015/084817 A1 relates to a composition comprising a synthetic zeolite having a CHA framework structure which may comprise iron and copper. WO 2020/089275 A1 relates to a selective catalytic reduction catalyst on a filter substrate. US 2019/368399 A1 relates to a particle filter with SCR-active coating. WO 2014/062944 A1 relates to a mixed metal 8-ring small pore molecular sieve catalyst compositions, catalytic articles, systems and methods.

In view of the above, there is a need of a catalyst that exhibits a low temperature NOₓ conversion as good as a known catalyst optimized for low temperature NOₓ conversion but which at the same time exhibits a reduced N₂O make, in particular at comparatively high temperatures and/or an improved high temperature NOₓ conversion.

### DETAILED DESCRIPTION

It was therefore an object of the present invention to provide an improved catalyst for the treatment of an exhaust gas of a diesel engine, in particular with respect to its NOₓ conversion and/or N₂O make, more particularly with respect to its NOₓ conversion at high temperatures and/or N₂O make at high temperatures, wherein within the meaning of the present invention high temperatures particularly include temperatures higher than 350° C.

Thus, it was surprisingly found that a catalyst for the treatment of a diesel exhaust gas can solve one or more of the above mentioned problems, in particular with respect to an improved performance with respect to the conversion of NOₓ and/or the N₂O make. Surprisingly, it was found that an improved catalyst can be provided according to the present invention in particular characterized as comprising a specific zeolitic material comprising Fe and Cu. Surprisingly, the catalyst of the present invention permits for an improved catalytic activity. Also, the catalyst of the present invention shows an excellent behavior as concerns N₂O make, in particular at comparatively high temperatures, more particularly at temperatures higher than 350° C.

It has been found that by doping a zeolitic material having framework structure type CHA with small amounts of Fe, in particular in the range of from 0.1 to 0.3 weight-%, in addition to a Cu-doping, the low temperature NOₓ conversion of the zeolitic material is not impacted strongly but the high temperature NOₓ conversion is strongly improved and/or the N₂O make is significantly reduced.

Therefore, the present invention relates to a process for preparing a catalyst for the treatment of an exhaust gas of a diesel engine, the process comprising
(i) preparing an aqueous mixture comprising water, a zeolitic material comprising Fe and having a framework structure type selected from the group consisting of CHA, AEI, RTH, LEV, DDR, KFI, ERI, AFX, a mixture of two or more thereof and a mixed type of two or more thereof, wherein the framework structure of the zeolitic material comprises Si, Al and O, the aqueous mixture further comprising a source of Cu and a first non-zeolitic oxidic material selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, wherein the aqueous mixture exhibits a weight ratio of Fe comprised in the zeolitic material, calculated as Fe₂O₃, relative to Cu comprised in the copper source, calculated as CuO, Fe₂O₃:CuO, of less than 0.1:1;
(ii) disposing the aqueous mixture obtained in (i) on the surface of the internal walls of a substrate comprising an inlet end, an outlet end, a substrate axial length extending from the inlet end to the outlet end and a plurality of passages defined by internal walls of the substrate extending therethrough, over at least 55% of the substrate axial length;
(iii) subjecting the substrate obtained in (ii) to a heat treatment in a gas atmosphere; obtaining the catalyst.

It is preferred that the zeolitic material according to (i) of the process has a framework structure type selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material according to (i) more preferably has a CHA framework structure type.

It is preferred that in the aqueous mixture according to (i) of the process, the weight ratio of Fe comprised in the zeolitic material according to (i), calculated as Fe₂O₃, relative to Cu comprised in the copper source, calculated as CuO, Fe₂O₃:CuO, is in the range of from 0.010:1 to 0.095:1, more preferably in the range of from 0.018:1 to 0.085:1, more preferably in the range of from 0.030:1 to 0.075:1, more preferably in the range of from 0.040:1 to 0.067:1.

It is preferred that from 95 to 100 weight-%, more preferably from 98 to 100 weight-%, more preferably from 99 to 100 weight-% of the framework structure of the zeolitic material according to (i) of the process consist of Si, Al, and O, wherein preferably from 98 to 100 weight-%, more preferably from 99 to 100 weight-%, more preferably from 99.5 to 100 weight-% of the zeolitic material according to (i) consist of Si, Al, O, Fe, and optionally H.

It is preferred that in the framework structure of the zeolitic material according to (i) of the process, the molar ratio of Si to Al, calculated as molar ratio of SiO₂:Al₂O₃, is in the range of from 1 to 50, more preferably in the range of from 8 to 35, more preferably in the range of from 13 to 23, more preferably in the range of from 16 to 20, more preferably in the range of from 17 to 19.

It is preferred that the Cu content, calculated as CuO, of the zeolitic material according to (i) of the process is in the range of from 0 to 0.001 weight-%, based on the sum of the weight of Si, calculated as SiO₂, and the weight of Al, calculated as Al₂O₃, comprised in the framework structure of the zeolitic material according to (i), wherein said zeolitic material more preferably is essentially free of Cu, wherein said zeolitic material more preferably does not comprise Cu.

It is preferred that the zeolitic material according to (i) of the process is obtainable or obtained by a method comprising
(a) providing a zeolitic material having a framework structure type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material more preferably has a CHA framework structure type,
   wherein the framework structure of the zeolitic material comprises Si, Al and O;
(b) providing, more preferably preparing, a solution comprising a dissolved iron salt, more preferably an aqueous solution comprising a dissolved iron salt;
(c) impregnating the zeolitic material provided in (a) with the solution provided in (b).

It is preferred that the process further comprises preparing the zeolitic material comprising Fe according to (i), said preparation method comprising
(a) providing a zeolitic material having framework structure type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material more preferably has a CHA framework structure type,
   wherein the framework structure of the zeolitic material comprises Si, Al and O;
(b) providing, more preferably preparing, a solution comprising a dissolved iron salt, more preferably an aqueous solution comprising a dissolved iron salt;
(c) impregnating the zeolitic material provided in (a) with the solution provided in (b).

In the case where the zeolitic material according to (i) of the process is obtainable or obtained by a method comprising (a), (b), and (c), or where the process further comprises preparing the zeolitic material comprising Fe according to (a), (b), and (c), it is preferred that from 95 to 100 weight-%, more preferably from 98 to 100 weight-%, more preferably from 99 to 100 weight-% of the framework structure of the zeolitic material according to (a) consist of Si, Al, and O, wherein more preferably from 98 to 100 weight-%, more preferably from 99 to 100 weight-%, more preferably from 99.5 to 100 weight-% of the zeolitic material according to (a) consist of Si, Al, O, and H.

In the case where the zeolitic material according to (i) of the process is obtainable or obtained by a method comprising (a), (b), and (c), or where the process further comprises preparing the zeolitic material comprising Fe according to (a), (b), and (c), it is preferred that in the framework structure of the zeolitic material according to (a), the molar ratio of Si to Al, calculated as molar ratio of SiO₂:Al₂O₃, is more preferably in the range of from 1 to 50, more preferably in the range of from 8 to 35, more preferably in the range of from 13 to 23, more preferably in the range of from 16 to 20, more preferably in the range of from 17 to 19.

In the case where the zeolitic material according to (i) of the process is obtainable or obtained by a method comprising (a), (b), and (c), or where the process further comprises preparing the zeolitic material comprising Fe according to (a), (b), and (c), it is preferred that the zeolitic material according to (a) is in its H-form or its NH₄⁺-form.

In the case where the zeolitic material according to (i) of the process is obtainable or obtained by a method comprising (a), (b), and (c), or where the process further comprises preparing the zeolitic material comprising Fe according to (a), (b), and (c), it is preferred that the zeolitic material according to (a) is a calcined zeolitic material, more preferably a zeolitic material calcined in a gas atmosphere having a temperature in the range of from 400 to 700° C., the gas atmosphere more preferably being one or more of oxygen, nitrogen, and air.

In the case where the zeolitic material according to (i) of the process is obtainable or obtained by a method comprising (a), (b), and (c), or where the process further comprises preparing the zeolitic material comprising Fe according to (a), (b), and (c), it is preferred that the zeolitic material according to (a) comprises from 0 to 0.1 weight-%, more preferably from 0 to 0.01 weight-%, more preferably from 0 to 0.001 weight-%, of one or more of Cu, Li, Na, and K, wherein the zeolitic material according to (a) more preferably is essentially free of, more preferably does not comprise, one or more of Cu, Li, Na, and K.

In the case where the zeolitic material according to (i) of the process is obtainable or obtained by a method comprising (a), (b), and (c), or where the process further comprises preparing the zeolitic material comprising Fe according to (a), (b), and (c), it is preferred that the zeolitic material according to (a) is in the form of particles characterized by a volume-based particle size distribution exhibiting a Dv90 value in the range of from 1 to 15 micrometer, more preferably in the range of from 3 to 9 micrometer, more preferably in the range of from 4 to 6 micrometer, the Dv90 value more preferably being determined as described in Reference Example 2.

In the case where the zeolitic material according to (i) of the process is obtainable or obtained by a method comprising (a), (b), and (c), or where the process further comprises preparing the zeolitic material comprising Fe according to (a), (b), and (c), it is preferred that the zeolitic material according to (a) is in the form of particles characterized by a volume-based particle size distribution exhibiting a Dv50 value in the range of from 0.5 to 10 micrometer, more preferably in the range of from 1 to 5 micrometer, more preferably in the range of from 2 to 3 micrometer, the Dv50 value more preferably being determined as described in Reference Example 2.

In the case where the zeolitic material according to (i) of the process is obtainable or obtained by a method comprising (a), (b), and (c), or where the process further comprises preparing the zeolitic material comprising Fe according to (a), (b), and (c), it is preferred that in the zeolitic material according to (a) the average crystal size is in the range of from 0.1 to 5 micrometer, more preferably in the range of from 0.2 to 2 micrometer, more preferably in the range of from 0.3 to 1 micrometer.

In the case where the zeolitic material according to (i) of the process is obtainable or obtained by a method comprising (a), (b), and (c), or where the process further comprises preparing the zeolitic material comprising Fe according to (a), (b), and (c), it is preferred that the volume ratio V(s):V(z) of the volume V(s) of the solution provided in (b) relative to the pore volume V(z) of the zeolitic material provided in (a) is in the range of from 0.5:1 to 1:1, more preferably in the range of from 0.7:1 to 1:1, more preferably in the range of from 0.8:1 to 1:1, wherein the pore volume V(z) is more preferably determined as described in Reference Example 1.

In the case where the zeolitic material according to (i) of the process is obtainable or obtained by a method comprising (a), (b), and (c), or where the process further comprises preparing the zeolitic material comprising Fe according to (a), (b), and (c), it is preferred that the iron salt according to (b) is an Fe(II) salt, an Fe(III) salt, or a mixture thereof, more preferably an Fe(III) salt, more preferably selected from the group consisting of Fe(III) nitrate, Fe(III) chloride, Fe(IIII) acetate, Fe(II) sulfate, and a mixture of two or more thereof, wherein more preferably, the iron salt comprises, more preferably consists of, Fe(III) nitrate.

In the case where the zeolitic material according to (i) of the process is obtainable or obtained by a method comprising (a), (b), and (c), or where the process further comprises preparing the zeolitic material comprising Fe according to (a), (b), and (c), it is preferred that from 95 to 100 weight-%, more preferably from 98 to 100 weight-%, more preferably from 99 to 100 weight-% of the solution according to (b) consist of water and the iron salt.

In the case where the zeolitic material according to (i) of the process is obtainable or obtained by a method comprising (a), (b), and (c), or where the process further comprises preparing the zeolitic material comprising Fe according to (a), (b), and (c), it is preferred that the process further comprises
(d) subjecting the impregnated zeolitic material obtained in (c) to drying in a gas atmosphere, the gas atmosphere more preferably being one or more of nitrogen, oxygen, and air, more preferably air;
   wherein during drying, the gas atmosphere more preferably has a temperature in the range of from 50 to 140° C.

In the case where the method comprising (a), (b), and (c) or where the process comprising (a), (b), and (c) further comprises (d), it is preferred that during drying according to (d), the temperature of the gas atmosphere was increased from a temperature in the range of from 50 to 70° C. to a temperature in the range of from 80 to 110° C., wherein the temperature of the gas atmosphere was more preferably increased from the temperature in the range of from 80 to 110° C. to a temperature in the range of from 120 to 140° C.

Further in the case where the zeolitic material according to (i) of the process is obtainable or obtained by a method comprising (a), (b), and (c), or where the process further comprises preparing the zeolitic material comprising Fe according to (a), (b), and (c), it is preferred that the process further comprises
(e) subjecting the impregnated zeolitic material obtained in (c), more preferably in (d), to calcination in a gas atmosphere, the gas atmosphere comprising, more preferably being, one or more of nitrogen, oxygen, and air, more preferably air;
   wherein during calcination, the gas atmosphere has a temperature in the range of from 550 to 650° C., more preferably in the range of from 570 to 610° C., more preferably in the range of from 580 to 600° C.

Further in the case where the zeolitic material according to (i) of the process is obtainable or obtained by a method comprising (a), (b), and (c), or where the process further comprises preparing the zeolitic material comprising Fe according to (a), (b), and (c), it is preferred that after impregnation according to (c), more preferably after drying according to (d) as defined in embodiment 20 or 21, and prior to (i), the zeolitic material is not subjected to calcination in a gas atmosphere comprising, more preferably being, air, preferably not subjected to calcination in a gas atmosphere comprising, more preferably being, one or more of nitrogen, oxygen, and air, more preferably not subjected to calcination in a gas atmosphere, said gas atmosphere more preferably having a temperature in the range of from 580 to 600° C., more preferably in the range of from 570 to 610° C., more preferably in the range of from 550 to 650° C.

It is preferred that the source of copper according to (i) of the process is a Cu(I) salt, a Cu(II) salt, or a mixture thereof, wherein the source of copper according to (i) is more preferably selected from the group consisting of copper acetate, copper nitrate, copper sulfate, copper formate, copper oxide, and a mixture of two or more thereof, more preferably selected from the group consisting of copper acetate, copper oxide, and a mixture thereof, wherein more preferably, the source of copper comprises, more preferably consists of, copper oxide, preferably CuO.

It is preferred that the aqueous mixture according to (i) of the process comprises the source of copper at an amount, calculated as CuO, in the range of from 0.025 to 7.5 weight-%, more preferably in the range of from 2 to 6.0 weight-%, more preferably in the range of from 3.5 to 5.5 weight-%, based on the sum of the weight of Si, calculated as SiO₂, and the weight of Al, calculated as Al₂O₃, comprised in the framework structure of the zeolitic material comprised in the aqueous mixture according to (i).

It is preferred that the first non-zeolitic oxidic material according to (i) of the process is selected from the group consisting of alumina, silica, titania, zirconia, a mixed oxide comprising one or more of Al, Si, Ti, and Zr, and a mixture of two or more thereof, more preferably selected from the group consisting of alumina, silica, zirconia, a mixed oxide comprising one or more of Al, Si, and Zr, and a mixture of two or more thereof, more preferably selected from the group consisting of alumina, zirconia, a mixed oxide comprising one or more of Al and Zr, and a mixture of two or more thereof, wherein the first non-zeolitic oxidic material according to (i) of the process more preferably comprises, more preferably consists of, zirconia-alumina.

In the case where the first non-zeolitic oxidic material according to (i) of the process is selected from the group consisting of alumina, silica, titania, zirconia, a mixed oxide comprising one or more of Al, Si, Ti, and Zr, and a mixture of two or more thereof, more preferably selected from the group consisting of alumina, silica, zirconia, a mixed oxide comprising one or more of Al, Si, and Zr, and a mixture of two or more thereof, more preferably selected from the group consisting of alumina, zirconia, a mixed oxide comprising one or more of Al and Zr, and a mixture of two or more thereof, wherein the first non-zeolitic oxidic material according to (i) of the process more preferably comprises, more preferably consists of, zirconia-alumina, it is preferred that from 30 to 100 weight-%, more preferably from 60 to 85 weight-%, more preferably from 75 to 82 weight-% of the first non-zeolitic oxidic material according to (i) consist of aluminum, calculated as Al₂O₃, and preferably from 5 to 35 weight-%, more preferably from 15 to 25 weight-%, more preferably from 18 to 22 weight-% of the first non-zeolitic oxidic material according to (i) consist of zirconium, calculated as ZrO₂.

It is preferred that the aqueous mixture according to (i) of the process comprises the first non-zeolitic oxidic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the aqueous mixture according to (i).

It is preferred that the aqueous mixture according to (i) of the process further comprises a source of a second non-zeolitic oxidic material which is different from the first non-zeolitic oxidic material, wherein the second non-zeolitic oxidic material is more preferably selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, more preferably selected from the group consisting of alumina, silica, titania, zirconia, and ceria, a mixed oxide comprising one or more of Al, Si, Ti, Zr, and Ce, and a mixture of two or more thereof, more preferably selected from the group consisting of silica, titania, zirconia, a mixed oxide comprising one or more of Si, Ti, and Zr, and a mixture of two or more thereof, wherein the second non-zeolitic oxidic material more preferably comprises, more preferably consists of, zirconia, wherein the aqueous mixture according to (i) more preferably comprises the second non-zeolitic oxidic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the aqueous mixture according to (i).

In the case where the aqueous mixture according to (i) of the process further comprises a source of a second non-zeolitic oxidic material which is different from the first non-zeolitic oxidic material, wherein the second non-zeolitic oxidic material is more preferably selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, more preferably selected from the group consisting of alumina, silica, titania, zirconia, and ceria, a mixed oxide comprising one or more of Al, Si, Ti, Zr, and Ce, and a mixture of two or more thereof, more preferably selected from the group consisting of silica, titania, zirconia, a mixed oxide comprising one or more of Si, Ti, and Zr, and a mixture of two or more thereof, wherein the second non-zeolitic oxidic material more preferably comprises, more preferably consists of, zirconia, wherein the aqueous mixture according to (i) more preferably comprises the second non-zeolitic oxidic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the aqueous mixture according to (i), it is preferred that the source of a second non-zeolitic oxidic material is one or more of an aluminum salt, a silicon salt, a zirconium salt, a titanium salt, a cerium salt, a praseodymium salt, a manganese salt, and a lanthanum salt, more preferably one or more of a zirconium salt, and an aluminum salt, more preferably a zirconium salt, more preferably one or more of zirconium acetate, zirconium hydroxide, zirconium chloride, zirconium nitrate, and zirconium sulfate, more preferably zirconium acetate.

Further in the case where the aqueous mixture according to (i) of the process further comprises a source of a second non-zeolitic oxidic material which is different from the first non-zeolitic oxidic material, wherein the the second non-zeolitic oxidic material is more preferably selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, more preferably selected from the group consisting of alumina, silica, titania, zirconia, and ceria, a mixed oxide comprising one or more of Al, Si, Ti, Zr, and Ce, and a mixture of two or more thereof, more preferably selected from the group consisting of silica, titania, zirconia, a mixed oxide comprising one or more of Si, Ti, and Zr, and a mixture of two or more thereof, wherein the second non-zeolitic oxidic material more preferably comprises, more preferably consists of, zirconia, wherein the aqueous mixture according to (i) more preferably comprises the second non-zeolitic oxidic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the aqueous mixture according to (i), it is preferred that the second non-zeolitic oxidic material consists of zirconia, and wherein the aqueous mixture according to (i) comprises the source of a second non-zeolitic oxidic material, calculated as ZrO₂, at an amount in the range of from 0.5 to 10 weight-%, more preferably in the range of from 2.5 to 5.5 weight-%, more preferably in the range of from 4.8 to 5.2 weight-%, based on the sum of the weight of Si, calculated as SiO₂, and the weight of Al, calculated as Al₂O₃, comprised in the framework structure of the zeolitic material comprised in the aqueous mixture according to (i).

It is preferred that (i) of the process comprises
(i.1) preparing a first aqueous mixture comprising water and the source of Cu;
(i.2) more preferably milling the first aqueous mixture, more preferably until the particles of the first aqueous mixture have a Dv90 in the range of from 4.5 to 7.5 micrometers, more preferably in the range of from 5.6 to 6.0 micrometers, the Dv90 being determined as described in Reference Example 2;
(i.3) optionally adding the source of a second non-zeolitic oxidic material as defined in any one of embodiments 29 to 31 in the first aqueous mixture obtained according to (i.1), preferably (i.2);
(i.4) preparing a second aqueous mixture comprising water and the zeolitic material comprising Fe and having framework structure type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material more preferably has a CHA framework structure type,
   wherein the framework structure of the zeolitic material comprises Si, Al and O;
(i.5) admixing the second aqueous mixture obtained in (i.4) with the first aqueous mixture obtained in (i.1), more preferably in (i.2) or in (i.3), obtaining a third aqueous mixture;
(i.6) more preferably milling the third aqueous mixture, more preferably until the particles of the third aqueous mixture have a Dv90 in the range of from 1.0 to 15 micrometers, preferably in the range of from 3.0 to 7.0 micrometers, more preferably in the range of from 4.8 to 5.6 micrometers, more preferably in the range of from 5.0 to 5.4 micrometers, more preferably in the range of from 5.1 to 5.3 micrometers, the Dv90 being determined as described in Reference Example 2;
(i.7) preparing a fourth aqueous mixture comprising water, and the first non-zeolitic oxidic material;
(i.8) admixing the fourth aqueous mixture obtained in (i.7) with the third aqueous mixture obtained in (i.5) or (i.6);
wherein (i) optionally consists of (i.1) to (i.8).

In the case where the process further comprises (i.1), preferably (i.2), optionally (i.3), (i.4), (i.5), preferably (i.6), (i.7), and (i.8), it is preferred the third aqueous mixture obtained in (i.5) has a pH in the range of from 2.0 to 5.0, more preferably in the range of from 2.4 to 4.5, more preferably in the range of from 3.4 to 4.2.

It is preferred that the aqueous mixture obtained in (i) of the process, more preferably in (i.8) according to embodiment 33, has a pH in the range of from 2.0 to 6.0, more preferably in the range of from 3.5 to 5.0, more preferably in the range of from 3.9 to 4.7.

It is preferred that the aqueous mixture obtained in (i) of the process is disposed on the surface of the internal walls of the substrate according to (ii) over 60 to 100%, more preferably over 80 to 100%, more preferably over 95 to 100% of the substrate axial length.

It is preferred that the aqueous mixture obtained in (i) of the process is disposed on the surface of the internal walls of the substrate according to (ii) from the inlet end or from the outlet end of the substrate.

It is preferred that the substrate according to (ii) of the process is a flow-through substrate or a wall flow filter substrate, more preferably a flow-through substrate, wherein the flow-through substrate is more preferably one or more of a cordierite flow-through substrate and a metallic flow-through substrate, more preferably a cordierite flow-through substrate, the substrate preferably having a cylindrical shape, the diameter of the substrate more preferably being in the range of from 25 to 380 millimeters, more preferably in the range of from 45 to 280 millimeters, more preferably in the range of from 55 to 200 millimeters, the substrate more preferably having an axial length in the range of from 40 to 254 millimeters, more preferably in the range of from 50 to 154 millimeters, more preferably in the range of from 75 to 127 millimeters.

It is preferred that the number of passages per square inch (number of passages per 6.4516 cm²) of the substrate according to (ii) of the process is in the range of from 100 to 1200 cpsi, more preferably in the range of from 200 to 900 cpsi, more preferably in the range of from 400 to 600 cpsi.

It is preferred that the gas atmosphere in (iii) of the process has a temperature in the range of from 60 to 150° C., more preferably in the range of from 70 to 140° C., wherein the heat treatment is more preferably conducted for a period in the range of from 0.1 to 2 h, more preferably in the range of from 0.4 to 0.6 h, wherein the gas atmosphere more preferably comprises, more preferably consists of, one or more of oxygen, nitrogen, and air, more preferably air.

It is preferred that the gas atmosphere in (iii) of the process has a temperature in the range of from 500 to 700° C., preferably in the range of from 570 to 610° C., wherein the heat treatment is more preferably conducted for a period in the range of from 0.5 to 5 h, more preferably in the range of from 1.5 to 2.5 h, wherein the gas atmosphere more preferably comprises, more preferably consists of, one or more of oxygen, nitrogen, and air, more preferably air.

It is preferred that the heat treatment in (iii) of the process comprises
(iii.1) subjecting the substrate obtained in (ii) to a first heat treatment in a gas atmosphere having a temperature in the range of from 60 to 150° C., more preferably in the range of from 70 to 140° C., wherein the first heat treatment is more preferably conducted for a period in the range of from 0.1 to 2 h, more preferably in the range of from 0.4 to 0.6 h, wherein the gas atmosphere more preferably comprises, more preferably consists of, one or more of oxygen, nitrogen, and air, more preferably air;
(iii.2) subjecting the substrate obtained in (iii.1) to a second heat treatment in a gas atmosphere having a temperature in the range of from 500 to 700° C., more preferably in the range of from 570 to 610° C., wherein the second heat treatment is more preferably conducted for a period in the range of from 0.5 to 5 h, more preferably in the range of from 1.5 to 2.5 h, wherein the gas atmosphere more preferably comprises, more preferably consists of, one or more of oxygen, nitrogen, and air, more preferably air.

Further, the present invention relates to a catalyst for the treatment of an exhaust gas of a diesel combustion engine, obtainable or obtained by a process according to any one of the embodiments disclosed herein.

Yet further, the present invention relates to a catalyst for the treatment of an exhaust gas of a diesel combustion engine, preferably the catalyst obtainable or obtained by a process according to any one of the embodiments disclosed herein, said catalyst comprising
(A) a substrate comprising an inlet end, an outlet end, a substrate axial length extending from the inlet end to the outlet end and a plurality of passages defined by internal walls of the substrate extending therethrough;
(B) a coating disposed on the surface of the internal walls of the substrate according to (A) over at least 55% of the substrate axial length, the coating comprising a first non-zeolitic oxidic material, Cu, and a zeolitic material comprising Fe and having a framework structure type selected from the group consisting of CHA, AEI, RTH, LEV, DDR, KFI, ERI, AFX, a mixture of two or more thereof and a mixed type of two or more thereof, wherein the framework structure of the zeolitic material comprises Si, Al and O,
   wherein the first non-zeolitic oxidic material selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof;
   wherein the coating according to (B) exhibits a weight ratio of Fe, calculated as Fe₂O₃, relative to Cu, calculated as CuO, Fe₂O₃:CuO, of less than 0.1:1.

It is preferred that the zeolitic material comprised in the coating according to (B) of the catalyst has a framework structure type selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material comprised in the coating according to (B) more preferably has a CHA framework structure type,

It is preferred that the coating according to (B) of the catalyst exhibits a weight ratio of Fe, calculated as Fe₂O₃, relative to Cu, calculated as CuO, Fe₂O₃:CuO, in the range of from 0.010:1 to 0.095:1, more preferably in the range of from 0.018:1 to 0.085:1, more preferably in the range of from 0.030:1 to 0.075:1, more preferably in the range of from 0.040:1 to 0.067:1.

It is preferred that the coating according to (B) of the catalyst exhibits a weight ratio of Fe, calculated as Fe₂O₃, relative to Cu, calculated as CuO, Fe₂O₃:CuO, in the range of from 0.040:1 to 0.098:1, more preferably in the range of from 0.060:1 to 0.097:1, more preferably in the range of from 0.070:1 to 0.096:1.

It is preferred that the copper comprised in the coating according to (B) of the catalyst is comprised in one or more of the zeolitic material comprised in the coating according to (B) and the first non-zeolitic oxidic material comprised in the coating according to (B).

It is preferred that from 75 to 100 weight-%, more preferably from 78 to 100 weight-%, more preferably from 80 to 100 weight-%, of the copper comprised in the coating according to (B) of the catalyst is comprised in the zeolitic material comprised in the coating according to (B).

It is preferred that the substrate according to (A) of the catalyst is a flow-through substrate or a wall flow filter substrate, more preferably a flow-through substrate, wherein the flow-through substrate is more preferably one or more of a cordierite flow-through substrate and a metallic flow-through substrate, more preferably a cordierite flow-through substrate.

It is preferred that the substrate according to (A) of the catalyst has a cylindrical shape, the diameter of the substrate more preferably being in the range of from 25 to 380 millimeters, more preferably in the range of from 45 to 280 millimeters, more preferably in the range of from 55 to 200 millimeters, the substrate more preferably having an axial length in the range of from 40 to 254 millimeters, more preferably in the range of from 50 to 154 millimeters, more preferably in the range of from 75 to 127 millimeters.

It is preferred that the number of passages per square inch (per 6.4516 cm²) of the substrate according to (A) of the catalyst is in the range of from 100 to 1200 cpsi, more preferably in the range of from 200 to 900 cpsi, more preferably in the range of from 400 to 600 cpsi.

It is preferred that from 95 to 100 weight-%, more preferably from 98 to 100 weight-%, more preferably from 99 to 100 weight-%, of the framework structure of the zeolitic material comprised in the coating according to (B) of the catalyst consist of Si, Al, and O.

It is preferred that the zeolitic material comprised in the coating according to (B) of the catalyst exhibits a molar ratio of silicon oxide to aluminum oxide, calculated as SiO₂ to Al₂O₃, SiO₂:Al₂O₃, in the range of from 1 to 50, more preferably in the range of from 8 to 35, more preferably in the range of from 13 to 23, more preferably in the range of from 16 to 20, more preferably in the range of from 17 to 19.

It is preferred that in the zeolitic material comprised in the coating according to (B) of the catalyst the average crystal size is in the range of from 0.1 to 5.0 micrometers, more preferably in the range of from 0.2 to 2.0 micrometers, more preferably in the range of from 0.3 to 1.0 micrometers.

It is preferred that the zeolitic material comprised in the coating according to (B) of the catalyst comprises Fe in an amount, calculated as Fe₂O₃, in the range of from 0.05 to 2 weight-%, more preferably in the range of from 0.1 to 1 weight-%, more preferably in the range of from 0.2 to 0.8 weight-%, based on the sum of the weight of Si, calculated as SiO₂, and the weight of Al, calculated as Al₂O₃, comprised in the framework structure of the zeolitic material comprised in the coating according to (B).

It is preferred that the first non-zeolitic oxidic material comprised in the coating according to (B) of the catalyst is selected from the group consisting of alumina, silica, titania, zirconia, a mixed oxide comprising one or more of Al, Si, Ti, and Zr, and a mixture of two or more thereof, more preferably selected from the group consisting of alumina, silica, zirconia, a mixed oxide comprising one or more of Al, Si, and Zr, and a mixture of two or more thereof, more preferably selected from the group consisting of alumina, zirconia, a mixed oxide comprising one or more of Al and Zr, and a mixture of two or more thereof, wherein the first non-zeolitic oxidic material comprised in the coating according to (B) more preferably comprises, more preferably consists of, zirconia-alumina.

It is preferred that the first non-zeolitic oxidic material comprised in the coating according to (B) of the catalyst comprises, preferably consists of, zirconia-alumina, wherein from 30 to 100 weight-%, more preferably from 60 to 85 weight-%, more preferably from 75 to 82 weight-%, of the zirconia-alumina consist of alumina.

It is preferred that the first non-zeolitic oxidic material comprised in the coating according to (B) of the catalyst comprises, more preferably consists of, zirconia-alumina, wherein from 5 to 35 weight-%, preferably from 15 to 25 weight-%, more preferably from 18 to 22 weight-%, of the zirconia-alumina consist of zirconia.

It is preferred that the catalyst comprises the first non-zeolitic oxidic material comprised in the coating according to (B) at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the coating according to (B).

It is preferred that the coating according to (B) of the catalyst further comprises a second non-zeolitic oxidic material, being different to the first non-zeolitic oxidic material, wherein the second non-zeolitic oxidic material is more preferably selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, more preferably selected from the group consisting of alumina, silica, titania, zirconia, and ceria, a mixed oxide comprising one or more of Al, Si, Ti, Zr, and Ce, and a mixture of two or more thereof, more preferably selected from the group consisting of silica, titania, zirconia, a mixed oxide comprising one or more of Si, Ti, and Zr, and a mixture of two or more thereof, wherein the second non-zeolitic oxidic material more preferably comprises, more preferably consists of, zirconia, wherein the catalyst more preferably comprises the second non-zeolitic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the coating according to (B).

In the case where the coating according to (B) of the catalyst further comprises a second non-zeolitic oxidic material, being different to the first non-zeolitic oxidic material, it is preferred that the copper comprised in the coating according to (B) is comprised in one or more of the zeolitic material comprised in the coating according to (B), the first non-zeolitic oxidic material comprised in the coating according to (B) and the second non-zeolitc oxidic material comprised in the coating according to (B).

It is preferred that the coating according to (B) of the catalyst comprises one or more of the zeolitic material, the first non-zeolitic oxidic material, and optionally the second non-zeolitic oxidic material as defined in embodiment 60, as particles, wherein said particles are more preferably characterized by a volume-based particle size distribution exhibiting a Dv90 value in the range of from 2 to 20 micrometers, more preferably in the range of from 5 to 15 micrometers, more preferably in the range of from 8 to 12 micrometers, the Dv90 value more preferably being determined as described in Reference Example 2.

It is preferred that the coating according to (B) of the catalyst comprises Cu, calculated as CuO, in an amount in the range of from 3.0 to 7.5 weight-%, more preferably in the range of from 4.5 to 5.8 weight-%, more preferably in the range of from 4.7 to 5.6 weight-%, based on the sum of the weight of Si, calculated as SiO₂, and the weight of Al, calculated as Al₂O₃, comprised in the framework structure of the zeolitic material comprised in the coating according to (B).

It is preferred that the coating according to (B) of the catalyst is disposed on the surface of the internal walls of the substrate according to (A) over 60 to 100%, more preferably over 80 to 100%, more preferably over 95 to 100% of the substrate axial length.

It is preferred that the zeolitic material comprised in the coating according to (B) of the catalyst is disposed on the surface of the internal walls of the substrate according to (A) at a loading in the range of from 1.00 to 4.50 g/in³, more preferably in the range of from 1.50 to 3.25 g/in³, more preferably in the range of from 1.65 to 3.10 g/in³.

It is preferred that the first non-zeolitic oxidic material comprised in the coating according to (B) of the catalyst is more preferably disposed on the surface of the internal walls of the substrate according to (A) at a loading in the range of from 0.05 to 0.25 g/in³, more preferably in the range of from 0.08 to 0.20 g/in³, more preferably in the range of from 0.11 to 0.16 g/in³.

Further in the case where the coating according to (B) of the catalyst further comprises a second non-zeolitic oxidic material, being different to the first non-zeolitic oxidic material, it is preferred that the second non-zeolitic oxidic material comprised in the coating according to (B) is disposed on the surface of the internal walls of the substrate according to (A) at a loading in the range of from 0.05 to 0.25 g/in³, more preferably in the range of from 0.08 to 0.20 g/in³, more preferably in the range of from 0.11 to 0.16 g/in³.

It is preferred that the catalyst has a Fe loading, calculated as Fe₂O₃, in the range of from 0.001 to 0.030 g/in³, more preferably in the range of from 0.003 to 0.015 g/in³, more preferably in the range of from 0.004 to 0.010 g/in³, wherein the Fe is more preferably comprised in the zeolitic material comprised in the coating according to (B).

It is preferred that the catalyst has a Cu loading, calculated as CuO, in the range of from 0.08 to 0.18 g/in³, more preferably in the range of from 0.10 to 0.16 g/in³ more preferably in the range of from 0.11 to 0.15 g/in³, wherein the Cu is more preferably at least partially comprised in the zeolitic material comprised in the coating according to (B).

It is preferred that the catalyst has a loading of the first non-zeolitic oxidic material comprised in the coating according to (B) in the range of from 1 to 10 weight-%, more preferably in the range of from 3 to 7 weight-%, more preferably in the range of from 4 to 6 weight-%, based on the sum of the weight of Si, calculated as SiO₂, and the weight of Al, calculated as Al₂O₃, comprised in the framework structure of the zeolitic material comprised in the coating according to (B).

It is preferred that from 95 to 100 weight-%, more preferably from 97 to 100 weight-%, more preferably from 99 to 100 weight-%, of the coating according to (B) of the catalyst consist of the zeolitic material comprised in the coating according to (B), Fe, Cu, O, and the first non-zeolitic oxidic material comprised in the coating according to (B).

It is preferred that the catalyst has a loading of the coating according to (B) in the range of from 1.0 to 5.0 g/in³, more preferably in the range of from 1.75 to 3.75 g/in³, more preferably in the range of from 1.9 to 3.5 g/in³.

It is preferred that from 95 to 100 weight-%, more preferably from 97 to 100 weight-%, more preferably from 99 to 100 weight-%, of the catalyst consist of the substrate according to (A) and the coating according to (B).

Yet further, the present invention relates to a system for the treatment of an exhaust gas of a diesel combustion engine, the system comprising a diesel oxidation catalyst, a catalyzed soot filter, and a catalyst according to any one of embodiments (42) to (73), wherein in said system, the diesel oxidation catalyst is located upstream of the catalyzed soot filter, and wherein the catalyzed soot filter is located upstream of said catalyst according to any one of embodiments (42) to (73).

It is preferred that the system further comprises a reductant injector, more preferably one or more of a hydrocarbon injector, a hydrocarbon in-cylinder post injector, and a urea injector, wherein the reductant injector is more preferably arranged upstream of the catalyzed soot filter, wherein the reductant injector is more preferably arranged downstream of the diesel oxidation catalyst.

Yet further, the present invention relates to a use of a catalyst of any one of the embodiments disclosed herein or a system of any one of the embodiments disclosed herein, for the treatment of an exhaust gas of a diesel combustion engine.

Yet further, the present invention relates to a method for treating an exhaust gas of a diesel combustion engine, said method comprising bringing said exhaust gas in contact with a catalyst according to any one of the embodiments disclosed herein.

Yet further, the present invention relates to a method for treating an exhaust gas of a diesel combustion engine, said method comprising passing said exhaust gas through a system according to any one of the embodiments disclosed herein.

The present invention is further illustrated by the following set of embodiments and combinations of embodiments resulting from the dependencies and back-references as indicated. In particular, it is noted that in each instance where a range of embodiments is mentioned, for example in the context of a term such as “A further preferred embodiment (4) concretizing any one of embodiments (1) to (3)”, every embodiment in this range is meant to be explicitly disclosed for the skilled person, i.e. the wording of this term is to be understood by the skilled person as being synonymous to “A further preferred embodiment (4) concretizing any one of embodiments (1), (2) and (3)”. Further, it is explicitly noted that the following set of embodiments is not the set of claims determining the extent of protection, but represents a suitably structured part of the description directed to general and preferred aspects of the present invention.

According to an embodiment (1), the present invention relates to a process for preparing a catalyst for the treatment of an exhaust gas of a diesel engine, comprising
(i) preparing an aqueous mixture comprising water, a zeolitic material comprising Fe and having a framework structure type selected from the group consisting of CHA, AEI, RTH, LEV, DDR, KFI, ERI, AFX, a mixture of two or more thereof and a mixed type of two or more thereof, wherein the framework structure of the zeolitic material comprises Si, Al and O, the aqueous mixture further comprising a source of Cu and a first non-zeolitic oxidic material selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof,
   wherein the aqueous mixture exhibits a weight ratio of Fe comprised in the zeolitic material, calculated as Fe2O3, relative to Cu comprised in the copper source, calculated as CuO, Fe₂O₃:CuO, of less than 0.1:1;
(ii) disposing the aqueous mixture obtained in (i) on the surface of the internal walls of a substrate comprising an inlet end, an outlet end, a substrate axial length extending from the inlet end to the outlet end and a plurality of passages defined by internal walls of the substrate extending therethrough, over at least 55% of the substrate axial length;
(iii) subjecting the substrate obtained in (ii) to a heat treatment in a gas atmosphere; obtaining the catalyst.

A preferred embodiment (2) concretizing embodiment (1) relates to said, wherein the zeolitic material according to (i) has a framework structure type selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material according to (i) more preferably has a CHA framework structure type.

A further preferred embodiment (3) concretizing embodiment (1) or (2) relates to said process, wherein in the aqueous mixture according to (i), the weight ratio of Fe comprised in the zeolitic material according to (i), calculated as Fe₂O₃, relative to Cu comprised in the copper source, calculated as CuO, Fe₂O₃:CuO, is in the range of from 0.010:1 to 0.095:1, more preferably in the range of from 0.018:1 to 0.085:1, more preferably in the range of from 0.030:1 to 0.075:1, more preferably in the range of from 0.040:1 to 0.067:1.

A further preferred embodiment (4) concretizing any one of embodiments (1) to (3) relates to said process, wherein from 95 to 100 weight-%, more preferably from 98 to 100 weight-%, more preferably from 99 to 100 weight-% of the framework structure of the zeolitic material according to (i) consist of Si, Al, and O, wherein preferably from 98 to 100 weight-%, more preferably from 99 to 100 weight-%, more preferably from 99.5 to 100 weight-% of the zeolitic material according to (i) consist of Si, Al, O, Fe, and optionally H.

A further preferred embodiment (5) concretizing any one of embodiments (1) to (4) relates to said process, wherein in the framework structure of the zeolitic material according to (i), the molar ratio of Si to Al, calculated as molar ratio of SiO₂:Al₂O₃, is in the range of from 1 to 50, more preferably in the range of from 8 to 35, more preferably in the range of from 13 to 23, more preferably in the range of from 16 to 20, more preferably in the range of from 17 to19.

A further preferred embodiment (6) concretizing any one of embodiments (1) to (5) relates to said process, wherein the Cu content, calculated as CuO, of the zeolitic material according to (i) is in the range of from 0 to 0.001 weight-%, based on the sum of the weight of Si, calculated as SiO₂, and the weight of Al, calculated as Al₂O₃, comprised in the framework structure of the zeolitic material according to (i), wherein said zeolitic material more preferably is essentially free of Cu, wherein said zeolitic material more preferably does not comprise Cu.

A further preferred embodiment (7) concretizing any one of embodiments (1) to (6) relates to said process, wherein the zeolitic material according to (i) is obtainable or obtained by a method comprising
(a) providing a zeolitic material having a framework structure type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material more preferably has a CHA framework structure type,
   wherein the framework structure of the zeolitic material comprises Si, Al and O;
(b) providing, more preferably preparing, a solution comprising a dissolved iron salt, more preferably an aqueous solution comprising a dissolved iron salt;
(c) impregnating the zeolitic material provided in (a) with the solution provided in (b).

A further preferred embodiment (8) concretizing any one of embodiments (1) to (6) relates to said process, wherein the process further comprises preparing the zeolitic material comprising Fe according to (i), said method comprising
(a) providing a zeolitic material having framework structure type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material more preferably has a CHA framework structure type,
   wherein the framework structure of the zeolitic material comprises Si, Al and O;
(b) providing, more preferably preparing, a solution comprising a dissolved iron salt, more preferably an aqueous solution comprising a dissolved iron salt;
(c) impregnating the zeolitic material provided in (a) with the solution provided in (b).

A further preferred embodiment (9) concretizing embodiment (7) or (8) relates to said process, wherein from 95 to 100 weight-%, more preferably from 98 to 100 weight-%, more preferably from 99 to 100 weight-% of the framework structure of the zeolitic material according to (a) consist of Si, Al, and O, wherein more preferably from 98 to 100 weight-%, more preferably from 99 to 100 weight-%, more preferably from 99.5 to 100 weight-% of the zeolitic material according to (a) consist of Si, Al, O, and H.

A further preferred embodiment (10) concretizing any one of embodiments (7) to (9) relates to said process, wherein in the framework structure of the zeolitic material according to (a), the molar ratio of Si to Al, calculated as molar ratio of SiO₂:Al₂O₃, is more preferably in the range of from 1 to 50, more preferably in the range of from 8 to 35, more preferably in the range of from 13 to 23, more preferably in the range of from 16 to 20, more preferably in the range of from 17 to 19.

A further preferred embodiment (11) concretizing any one of embodiments (7) to (10) relates to said process, wherein the zeolitic material according to (a) is in its H-form or its NH₄⁺-form.

A further preferred embodiment (12) concretizing any one of embodiments (7) to (11) relates to said process, wherein the zeolitic material according to (a) is a calcined zeolitic material, more preferably a zeolitic material calcined in a gas atmosphere having a temperature in the range of from 400 to 700° C., the gas atmosphere more preferably being one or more of oxygen, nitrogen, and air.

A further preferred embodiment (13) concretizing any one of embodiments (7) to (12) relates to said process, wherein the zeolitic material according to (a) comprises from 0 to 0.1 weight-%, more preferably from 0 to 0.01 weight-%, more preferably from 0 to 0.001 weight-%, of one or more of Cu, Li, Na, and K, wherein the zeolitic material according to (a) more preferably is essentially free of, more preferably does not comprise, one or more of Cu, Li, Na, and K.

A further preferred embodiment (14) concretizing any one of embodiments (7) to (13) relates to said process, wherein the zeolitic material according to (a) is in the form of particles characterized by a volume-based particle size distribution exhibiting a Dv90 value in the range of from 1 to 15 micrometer, more preferably in the range of from 3 to 9 micrometer, more preferably in the range of from 4 to 6 micrometer, the Dv90 value more preferably being determined as described in Reference Example 2.

A further preferred embodiment (15) concretizing any one of embodiments (7) to (14) relates to said process, wherein the zeolitic material according to (a) is in the form of particles characterized by a volume-based particle size distribution exhibiting a Dv50 value in the range of from 0.5 to 10 micrometer, more preferably in the range of from 1 to 5 micrometer, more preferably in the range of from 2 to 3 micrometer, the Dv50 value more preferably being determined as described in Reference Example 2.

A further preferred embodiment (16) concretizing any one of embodiments (7) to (15) relates to said process, wherein in the zeolitic material according to (a) the average crystal size is in the range of from 0.1 to 5 micrometer, more preferably in the range of from 0.2 to 2 micrometer, more preferably in the range of from 0.3 to 1 micrometer.

A further preferred embodiment (17) concretizing any one of embodiments (7) to (16) relates to said process, wherein the volume ratio V(s):V(z) of the volume V(s) of the solution provided in (b) relative to the pore volume V(z) of the zeolitic material provided in (a) is in the range of from 0.5:1 to 1:1, more preferably in the range of from 0.7:1 to 1:1, more preferably in the range of from 0.8:1 to 1:1, wherein the pore volume V(z) is more preferably determined as described in Reference Example 1.

A further preferred embodiment (18) concretizing any one of embodiments (7) to (17) relates to said process, wherein the iron salt according to (b) is an Fe(II) salt, an Fe(III) salt, or a mixture thereof, more preferably an Fe(III) salt, more preferably selected from the group consisting of Fe(III) nitrate, Fe(III) chloride, Fe(IIII) acetate, Fe(II) sulfate, and a mixture of two or more thereof, wherein more preferably, the iron salt comprises, more preferably consists of, Fe(III) nitrate.

A further preferred embodiment (19) concretizing any one of embodiments (7) to (18) relates to said process, wherein from 95 to 100 weight-%, more preferably from 98 to 100 weight-%, more preferably from 99 to 100 weight-% of the solution according to (b) consist of water and the iron salt.

A further preferred embodiment (20) concretizing any one of embodiments (7) to (19) relates to said process, wherein the process further comprises
(d) subjecting the impregnated zeolitic material obtained in (c) to drying in a gas atmosphere, the gas atmosphere more preferably being one or more of nitrogen, oxygen, and air, more preferably air;
wherein during drying, the gas atmosphere more preferably has a temperature in the range of from 50 to 140° C.

A further preferred embodiment (21) concretizing embodiment (20) relates to said process, wherein during drying according to (d), the temperature of the gas atmosphere was increased from a temperature in the range of from 50 to 70° C. to a temperature in the range of from 80 to 110° C., wherein the temperature of the gas atmosphere was more preferably increased from the temperature in the range of from 80 to 110° C. to a temperature in the range of from 120 to 140° C.

A further preferred embodiment (22) concretizing any one of embodiments (7) to (21), more preferably (20) or (21), relates to said process, wherein the process further comprises
(e) subjecting the impregnated zeolitic material obtained in (c), more preferably in (d), to calcination in a gas atmosphere, the gas atmosphere comprising, more preferably being, one or more of nitrogen, oxygen, and air, more preferably air;
   wherein during calcination, the gas atmosphere has a temperature in the range of from 550 to 650° C., more preferably in the range of from 570 to 610° C., more preferably in the range of from 580 to 600° C.

A further preferred embodiment (23) concretizing any one of embodiments (7) to (21) relates to said process, wherein after impregnation according to (c), more preferably after drying according to (d) as defined in embodiment 20 or 21, and prior to (i), the zeolitic material is not subjected to calcination in a gas atmosphere comprising, more preferably being, air, preferably not subjected to calcination in a gas atmosphere comprising, more preferably being, one or more of nitrogen, oxygen, and air, more preferably not subjected to calcination in a gas atmosphere, said gas atmosphere more preferably having a temperature in the range of from 580 to 600° C., more preferably in the range of from 570 to 610° C., more preferably in the range of from 550 to 650° C.

A further preferred embodiment (24) concretizing any one of embodiments (1) to (23) relates to said process, wherein the source of copper according to (i) is a Cu(I) salt, a Cu(II) salt, or a mixture thereof, wherein the source of copper according to (i) is more preferably selected from the group consisting of copper acetate, copper nitrate, copper sulfate, copper formate, copper oxide, and a mixture of two or more thereof, more preferably selected from the group consisting of copper acetate, copper oxide, and a mixture thereof, wherein more preferably, the source of copper comprises, more preferably consists of, copper oxide, preferably CuO.

A further preferred embodiment (25) concretizing any one of embodiments (1) to (24) relates to said process, wherein the aqueous mixture according to (i) comprises the source of copper at an amount, calculated as CuO, in the range of from 0.025 to 7.5 weight-%, more preferably in the range of from 2 to 6.0 weight-%, more preferably in the range of from 3.5 to 5.5 weight-%, based on the sum of the weight of Si, calculated as SiO₂, and the weight of Al, calculated as Al₂O₃, comprised in the framework structure of the zeolitic material comprised in the aqueous mixture according to (i).

A further preferred embodiment (26) concretizing any one of embodiments (1) to (25) relates to said process, wherein the first non-zeolitic oxidic material according to (i) of the process is selected from the group consisting of alumina, silica, titania, zirconia, a mixed oxide comprising one or more of Al, Si, Ti, and Zr, and a mixture of two or more thereof, more preferably selected from the group consisting of alumina, silica, zirconia, a mixed oxide comprising one or more of Al, Si, and Zr, and a mixture of two or more thereof, more preferably selected from the group consisting of alumina, zirconia, a mixed oxide comprising one or more of Al and Zr, and a mixture of two or more thereof, wherein the first non-zeolitic oxidic material according to (i) of the process more preferably comprises, more preferably consists of, zirconia-alumina.

A further preferred embodiment (27) concretizing embodiment (26) relates to said process, wherein from 30 to 100 weight-%, preferably from 60 to 85 weight-%, more preferably from 75 to 82 weight-% of the first non-zeolitic oxidic material according to (i) consist of aluminum, calculated as Al₂O₃, and preferably from 5 to 35 weight-%, more preferably from 15 to 25 weight-%, more preferably from 18 to 22 weight-% of the first non-zeolitic oxidic material according to (i) consist of zirconium, calculated as ZrO₂.

A further preferred embodiment (28) concretizing any one of embodiments (1) to (27) relates to said process, wherein the aqueous mixture according to (i) comprises the first non-zeolitic oxidic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the aqueous mixture according to (i).

A further preferred embodiment (29) concretizing any one of embodiments (1) to (28) relates to said process, wherein the aqueous mixture according to (i) further comprises a source of a second non-zeolitic oxidic material which is different from the first non-zeolitic oxidic material, wherein the the second non-zeolitic oxidic material is more preferably selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, more preferably selected from the group consisting of alumina, silica, titania, zirconia, and ceria, a mixed oxide comprising one or more of Al, Si, Ti, Zr, and Ce, and a mixture of two or more thereof, more preferably selected from the group consisting of silica, titania, zirconia, a mixed oxide comprising one or more of Si, Ti, and Zr, and a mixture of two or more thereof, wherein the second non-zeolitic oxidic material more preferably comprises, more preferably consists of, zirconia, wherein the aqueous mixture according to (i) more preferably comprises the second non-zeolitic oxidic material at an amount in the range of from greater than to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the aqueous mixture according to (i).

A further preferred embodiment (30) concretizing embodiment (29) relates to said process, wherein the source of a second non-zeolitic oxidic material is one or more of an aluminum salt, a silicon salt, a zirconium salt, a titanium salt, a cerium salt, a praseodymium salt, a manganese salt, and a lanthanum salt, more preferably one or more of a zirconium salt, and an aluminum salt, more preferably a zirconium salt, more preferably one or more of zirconium acetate, zirconium hydroxide, zirconium chloride, zirconium nitrate, and zirconium sulfate, more preferably zirconium acetate.

A further preferred embodiment (30) concretizing embodiment (29) or (30) relates to said process, wherein the second non-zeolitic oxidic material consists of zirconia, and wherein the aqueous mixture according to (i) comprises the source of a second non-zeolitic oxidic material, calculated as ZrO₂, at an amount in the range of from 0.5 to 10 weight-%, more preferably in the range of from 2.5 to 5.5 weight-%, more preferably in the range of from 4.8 to 5.2 weight-%, based on the sum of the weight of Si, calculated as SiO₂, and the weight of Al, calculated as Al₂O₃, comprised in the framework structure of the zeolitic material comprised in the aqueous mixture according to (i).

A further preferred embodiment (32) concretizing any one of embodiments (1) to (31) relates to said process, wherein (i) comprises
(i.1) preparing a first aqueous mixture comprising water and the source of Cu;
(i.2) preferably milling the first aqueous mixture, more preferably until the particles of the first aqueous mixture have a Dv90 in the range of from 4.5 to 7.5 micrometers, more preferably in the range of from 5.6 to 6.0 micrometers, the Dv90 being determined as described in Reference Example 2;
(i.3) optionally adding the source of a second non-zeolitic oxidic material as defined in any one of embodiments 29 to 31 in the first aqueous mixture obtained according to (i.1), preferably (i.2);
(i.4) preparing a second aqueous mixture comprising water and the zeolitic material comprising Fe and having framework structure type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material more preferably has a CHA framework structure type,
   wherein the framework structure of the zeolitic material comprises Si, Al and O;
(i.5) admixing the second aqueous mixture obtained in (i.4) with the first aqueous mixture obtained in (i.1), more preferably in (i.2) or in (i.3), obtaining a third aqueous mixture;
(i.6) preferably milling the third aqueous mixture, more preferably until the particles of the third aqueous mixture have a Dv90 in the range of from 1.0 to 15 micrometers, preferably in the range of from 3.0 to 7.0 micrometers, more preferably in the range of from 4.8 to 5.6 micrometers, more preferably in the range of from 5.0 to 5.4 micrometers, more preferably in the range of from 5.1 to 5.3 micrometers, the Dv90 being determined as described in Reference Example 2;
(i.7) preparing a fourth aqueous mixture comprising water, and the first non-zeolitic oxidic material;
(i.8) admixing the fourth aqueous mixture obtained in (i.7) with the third aqueous mixture obtained in (i.5) or (i.6);
wherein (i) optionally consists of (i.1) to (i.8).

A further preferred embodiment (33) concretizing embodiment (32) relates to said process, wherein the third aqueous mixture obtained in (i.5) has a pH in the range of from 2.0 to 5.0, more preferably in the range of from 2.4 to 4.5, more preferably in the range of from 3.4 to 4.2.

A further preferred embodiment (34) concretizing any one of embodiments (1) to (33) relates to said process, wherein the aqueous mixture obtained in (i), more preferably in (i.8) according to embodiment 33, has a pH in the range of from 2.0 to 6.0, more preferably in the range of from 3.5 to 5.0, more preferably in the range of from 3.9 to 4.7.

A further preferred embodiment (35) concretizing any one of embodiments (1) to (34) relates to said process, wherein the aqueous mixture obtained in (i) is disposed on the surface of the internal walls of the substrate according to (ii) over 60 to 100%, more preferably over 80 to 100%, more preferably over 95 to 100% of the substrate axial length.

A further preferred embodiment (36) concretizing any one of embodiments (1) to (35) relates to said process, wherein the aqueous mixture obtained in (i) is disposed on the surface of the internal walls of the substrate according to (ii) from the inlet end or from the outlet end of the substrate.

A further preferred embodiment (37) concretizing any one of embodiments (1) to (36) relates to said process, wherein the substrate according to (ii) is a flow-through substrate or a wall flow filter substrate, more preferably a flow-through substrate, wherein the flow-through substrate is more preferably one or more of a cordierite flow-through substrate and a metallic flow-through substrate, more preferably a cordierite flow-through substrate, the substrate preferably having a cylindrical shape, the diameter of the substrate more preferably being in the range of from 25 to 380 millimeters, more preferably in the range of from 45 to 280 millimeters, more preferably in the range of from 55 to 200 millimeters, the substrate more preferably having an axial length in the range of from 40 to 254 millimeters, more preferably in the range of from 50 to 154 millimeters, more preferably in the range of from 75 to 127 millimeters.

A further preferred embodiment (38) concretizing any one of embodiments (1) to (37) relates to said process, wherein the number of passages per square inch (number of passages per 6.4516 cm²) of the substrate according to (ii) is in the range of from 100 to 1200 cpsi, more preferably in the range of from 200 to 900 cpsi, more preferably in the range of from 400 to 600 cpsi.

A further preferred embodiment (39) concretizing any one of embodiments (1) to (38) relates to said process, wherein the gas atmosphere in (iii) has a temperature in the range of from 60 to 150° C., more preferably in the range of from 70 to 140° C., wherein the heat treatment is more preferably conducted for a period in the range of from 0.1 to 2 h, more preferably in the range of from 0.4 to 0.6 h, wherein the gas atmosphere more preferably comprises, more preferably consists of, one or more of oxygen, nitrogen, and air, more preferably air.

A further preferred embodiment (40) concretizing any one of embodiments (1) to (38) relates to said process, wherein the gas atmosphere in (iii) has a temperature in the range of from 500 to 700° C., preferably in the range of from 570 to 610° C., wherein the heat treatment is more preferably conducted for a period in the range of from 0.5 to 5 h, more preferably in the range of from 1.5 to 2.5 h, wherein the gas atmosphere more preferably comprises, more preferably consists of, one or more of oxygen, nitrogen, and air, more preferably air.

A further preferred embodiment (41) concretizing any one of embodiments (1) to (38) relates to said process, wherein the heat treatment in (iii) comprises
(iii.1) subjecting the substrate obtained in (ii) to a first heat treatment in a gas atmosphere having a temperature in the range of from 60 to 150° C., more preferably in the range of from 70 to 140° C., wherein the first heat treatment is more preferably conducted for a period in the range of from 0.1 to 2 h, more preferably in the range of from 0.4 to 0.6 h, wherein the gas atmosphere more preferably comprises, more preferably consists of, one or more of oxygen, nitrogen, and air, more preferably air;
(iii.2) subjecting the substrate obtained in (iii.1) to a second heat treatment in a gas atmosphere having a temperature in the range of from 500 to 700° C., more preferably in the range of from 570 to 610° C., wherein the second heat treatment is more preferably conducted for a period in the range of from 0.5 to 5 h, more preferably in the range of from 1.5 to 2.5 h, wherein the gas atmosphere more preferably comprises, more preferably consists of, one or more of oxygen, nitrogen, and air, more preferably air.

An embodiment (42) of the present invention relates to a catalyst for the treatment of an exhaust gas of a diesel combustion engine, obtainable or obtained by a process according to any one of embodiments (1) to (41).

An embodiment (43) of the present invention relates to a catalyst for the treatment of an exhaust gas of a diesel combustion engine, preferably the catalyst of embodiment (42), said catalyst comprising
(A) a substrate comprising an inlet end, an outlet end, a substrate axial length extending from the inlet end to the outlet end and a plurality of passages defined by internal walls of the substrate extending therethrough;
(B) a coating disposed on the surface of the internal walls of the substrate according to (A) over at least 55% of the substrate axial length, the coating comprising a first non-zeolitic oxidic material, Cu, and a zeolitic material comprising Fe and having a framework structure type selected from the group consisting of CHA, AEI, RTH, LEV, DDR, KFI, ERI, AFX, a mixture of two or more thereof and a mixed type of two or more thereof, wherein the framework structure of the zeolitic material comprises Si, Al and O,
   wherein the first non-zeolitic oxidic material selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof;
   wherein the coating according to (B) exhibits a weight ratio of Fe, calculated as Fe₂O₃, relative to Cu, calculated as CuO, Fe₂O₃:CuO, of less than 0.1:1.

A preferred embodiment (44) concretizing embodiment (43) relates to said catalyst, wherein the zeolitic material comprised in the coating according to (B) has a framework structure type selected from the group consisting of CHA, AEI, RTH, a mixture of two or more thereof and a mixed type of two or more thereof, more preferably selected from the group consisting of CHA and AEI, a mixture thereof and a mixed type thereof, wherein the zeolitic material comprised in the coating according to (B) more preferably has a CHA framework structure type,

A preferred embodiment (45) concretizing embodiment (43) or (44) relates to said catalyst, wherein the coating according to (B) exhibits a weight ratio of Fe, calculated as Fe₂O₃, relative to Cu, calculated as CuO, Fe₂O₃:CuO, in the range of from 0.010:1 to 0.095:1, more preferably in the range of from 0.018:1 to 0.085:1, more preferably in the range of from 0.030:1 to 0.075:1, more preferably in the range of from 0.040:1 to 0.067:1.

A preferred embodiment (46) concretizing embodiment (43) or (44) relates to said catalyst, wherein the coating according to (B) exhibits a weight ratio of Fe, calculated as Fe₂O₃, relative to Cu, calculated as CuO, Fe₂O₃:CuO, in the range of from 0.040:1 to 0.098:1, more preferably in the range of from 0.060:1 to 0.097:1, more preferably in the range of from 0.070:1 to 0.096:1.

A further preferred embodiment (47) concretizing any one of embodiments (43) to (46) relates to said catalyst, wherein the copper comprised in the coating according to (B) is comprised in one or more of the zeolitic material comprised in the coating according to (B) and the first non-zeolitic oxidic material comprised in the coating according to (B).

A further preferred embodiment (48) concretizing any one of embodiments (43) to (47) relates to said catalyst, wherein from 75 to 100 weight-%, more preferably from 78 to 100 weight-%, more preferably from 80 to 100 weight-%, of the copper comprised in the coating according to (B) is comprised in the zeolitic material comprised in the coating according to (B).

A further preferred embodiment (49) concretizing any one of embodiments (43) to (45) relates to said catalyst, wherein the substrate according to (A) is a flow-through substrate or a wall flow filter substrate, more preferably a flow-through substrate, wherein the flow-through substrate is more preferably one or more of a cordierite flow-through substrate and a metallic flow-through substrate, more preferably a cordierite flow-through substrate.

A further preferred embodiment (50) concretizing any one of embodiments (43) to (49) relates to said catalyst, wherein the substrate according to (A) has a cylindrical shape, the diameter of the substrate more preferably being in the range of from 25 to 380 millimeters, more preferably in the range of from 45 to 280 millimeters, more preferably in the range of from 55 to 200 millimeters, the substrate more preferably having an axial length in the range of from 40 to 254 millimeters, more preferably in the range of from 50 to 154 millimeters, more preferably in the range of from 75 to 127 millimeters.

A further preferred embodiment (51) concretizing any one of embodiments (43) to (50) relates to said catalyst, wherein the number of passages per square inch (per 6.4516 cm²) of the substrate according to (A) is in the range of from 100 to 1200 cpsi, more preferably in the range of from 200 to 900 cpsi, more preferably in the range of from 400 to 600 cpsi.

A further preferred embodiment (52) concretizing any one of embodiments (43) to (51) relates to said catalyst, wherein from 95 to 100 weight-%, more preferably from 98 to 100 weight-%, more preferably from 99 to 100 weight-%, of the framework structure of the zeolitic material comprised in the coating according to (B) consist of Si, Al, and O.

A further preferred embodiment (53) concretizing any one of embodiments (43) to (52) relates to said catalyst, wherein the zeolitic material comprised in the coating according to (B) exhibits a molar ratio of silicon oxide to aluminum oxide, calculated as SiO₂ to Al₂O₃, SiO₂:Al₂O₃, in the range of from 1 to 50, more preferably in the range of from 8 to 35, more preferably in the range of from 13 to 23, more preferably in the range of from 16 to 20, more preferably in the range of from 17 to 19.

A further preferred embodiment (54) concretizing any one of embodiments (43) to (53) relates to said catalyst, wherein in the zeolitic material comprised in the coating according to (B) the average crystal size is in the range of from 0.1 to 5.0 micrometers, more preferably in the range of from 0.2 to 2.0 micrometers, more preferably in the range of from 0.3 to 1.0 micrometers.

A further preferred embodiment (55) concretizing any one of embodiments (43) to (54) relates to said catalyst, wherein the zeolitic material comprised in the coating according to (B) comprises Fe in an amount, calculated as Fe₂O₃, in the range of from 0.05 to 2 weight-%, more preferably in the range of from 0.1 to 1 weight-%, more preferably in the range of from 0.2 to 0.8 weight-%, based on the sum of the weight of Si, calculated as SiO₂, and the weight of Al, calculated as Al₂O₃, comprised in the framework structure of the zeolitic material comprised in the coating according to (B).

A further preferred embodiment (56) concretizing any one of embodiments (43) to (55) relates to said catalyst, wherein the first non-zeolitic oxidic material comprised in the coating according to (B) of the catalyst is selected from the group consisting of alumina, silica, titania, zirconia, a mixed oxide comprising one or more of Al, Si, Ti, and Zr, and a mixture of two or more thereof, more preferably selected from the group consisting of alumina, silica, zirconia, a mixed oxide comprising one or more of Al, Si, and Zr, and a mixture of two or more thereof, more preferably selected from the group consisting of alumina, zirconia, a mixed oxide comprising one or more of Al and Zr, and a mixture of two or more thereof, wherein the first non-zeolitic oxidic material comprised in the coating according to (B) more preferably comprises, more preferably consists of, zirconia-alumina.

A further preferred embodiment (57) concretizing any one of embodiments (43) to (56) relates to said catalyst, wherein the first non-zeolitic oxidic material comprised in the coating according to (B) comprises, preferably consists of, zirconia-alumina, wherein from 30 to 100 weight-%, more preferably from 60 to 85 weight-%, more preferably from 75 to 82 weight-%, of the zirconia-alumina consist of alumina.

A further preferred embodiment (58) concretizing any one of embodiments (43) to (57) relates to said catalyst, wherein the first non-zeolitic oxidic material comprised in the coating according to (B) comprises, more preferably consists of, zirconia-alumina, wherein from 5 to 35 weight-%, preferably from 15 to 25 weight-%, more preferably from 18 to 22 weight-%, of the zirconia-alumina consist of zirconia.

A further preferred embodiment (59) concretizing any one of embodiments (43) to (58) relates to said catalyst, wherein the catalyst comprises the first non-zeolitic oxidic material comprised in the coating according to (B) at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the coating according to (B).

A further preferred embodiment (60) concretizing any one of embodiments (43) to (59) relates to said catalyst, wherein the coating according to (B) further comprises a second non-zeolitic oxidic material, being different to the first non-zeolitic oxidic material, wherein the second non-zeolitic oxidic material is more preferably selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof, more preferably selected from the group consisting of alumina, silica, titania, zirconia, and ceria, a mixed oxide comprising one or more of Al, Si, Ti, Zr, and Ce, and a mixture of two or more thereof, more preferably selected from the group consisting of silica, titania, zirconia, a mixed oxide comprising one or more of Si, Ti, and Zr, and a mixture of two or more thereof, wherein the second non-zeolitic oxidic material more preferably comprises, more preferably consists of, zirconia,
wherein the catalyst more preferably comprises the second non-zeolitic material at an amount in the range of from greater than 0 to 20 weight-%, more preferably in the range of from 0.5 to 10.5 weight-%, more preferably in the range of from 2.0 to 5.5 weight-%, more preferably in the range of from 3.5 to 5.2 weight-%, based on the sum of the weight of Si, calculated as SiO₂, and the weight of Al, calculated as Al₂O₃, comprised in the framework structure of the zeolitic material comprised in the coating according to (B).

A further preferred embodiment (61) concretizing embodiment (60) relates to said catalyst, wherein the copper comprised in the coating according to (B) is comprised in one or more of the zeolitic material comprised in the coating according to (B), the first non-zeolitic oxidic material comprised in the coating according to (B) and the second non-zeolitc oxidic material comprised in the coating according to (B).

A further preferred embodiment (62) concretizing any one of embodiments (43) to (61) relates to said catalyst, wherein the coating according to (B) comprises one or more of the zeolitic material, the first non-zeolitic oxidic material, and optionally the second non-zeolitic oxidic material as defined in embodiment 60, as particles, wherein said particles are more preferably characterized by a volume-based particle size distribution exhibiting a Dv90 value in the range of from 2 to 20 micrometers, more preferably in the range of from 5 to 15 micrometers, more preferably in the range of from 8 to 12 micrometers, the Dv90 value more preferably being determined as described in Reference Example 2.

A further preferred embodiment (63) concretizing any one of embodiments (43) to (62) relates to said catalyst, wherein the coating according to (B) comprises Cu in an amount, calculated as CuO, in the range of from 3.0 to 7.5 weight-%, more preferably in the range of from 4.5 to 5.8 weight-%, more preferably in the range of from 4.7 to 5.6 weight-%, based on the sum of the weight of Si, calculated as SiO₂, and the weight of Al, calculated as Al₂O₃, comprised in the framework structure of the zeolitic material comprised in the coating according to (B).

A further preferred embodiment (64) concretizing any one of embodiments (43) to (63) relates to said catalyst, wherein the coating according to (B) is disposed on the surface of the internal walls of the substrate according to (A) over 60 to 100%, more preferably over 80 to 100%, more preferably over 95 to 100% of the substrate axial length.

A further preferred embodiment (65) concretizing any one of embodiments (43) to (64) relates to said catalyst, wherein the zeolitic material comprised in the coating according to (B) is disposed on the surface of the internal walls of the substrate according to (A) at a loading in the range of from 1.00 to 4.50 g/in³, more preferably in the range of from 1.50 to 3.25 g/in³, more preferably in the range of from 1.65 to 3.10 g/in³.

A further preferred embodiment (66) concretizing any one of embodiments (43) to (65) relates to said catalyst, wherein the first non-zeolitic oxidic material comprised in the coating according to (B) is more preferably disposed on the surface of the internal walls of the substrate according to (A) at a loading in the range of from 0.05 to 0.25 g/in³, more preferably in the range of from 0.08 to 0.20 g/in³, more preferably in the range of from 0.11 to 0.16 g/in³.

A further preferred embodiment (67) concretizing any one of embodiments (60) to (66) relates to said catalyst, wherein the second non-zeolitic oxidic material comprised in the coating according to (B) is disposed on the surface of the internal walls of the substrate according to (A) at a loading in the range of from 0.05 to 0.25 g/in³, more preferably in the range of from 0.08 to 0.20 g/in³, more preferably in the range of from 0.11 to 0.16 g/in³.

A further preferred embodiment (68) concretizing any one of embodiments (43) to (67) relates to said catalyst, wherein the catalyst has a Fe loading, calculated as Fe₂O₃, in the range of from 0.001 to 0.030 g/in³, more preferably in the range of from 0.003 to 0.015 g/in³, more preferably in the range of from 0.004 to 0.010 g/in³, wherein the Fe is more preferably comprised in the zeolitic material comprised in the coating according to (B).

A further preferred embodiment (69) concretizing any one of embodiments (43) to (68) relates to said catalyst, wherein the catalyst has a Cu loading, calculated as CuO, in the range of from 0.08 to 0.18 g/in³, more preferably in the range of from 0.10 to 0.16 g/in³ more preferably in the range of from 0.11 to 0.15 g/in³, wherein the Cu is more preferably at least partially comprised in the zeolitic material comprised in the coating according to (B).

A further preferred embodiment (70) concretizing any one of embodiments (43) to (69) relates to said catalyst, wherein the catalyst has a loading of the first non-zeolitic oxidic material comprised in the coating according to (B) in the range of from 1 to 10 weight-%, more preferably in the range of from 3 to 7 weight-%, more preferably in the range of from 4 to 6 weight-%, based on the sum of the weight of Si, calculated as SiO₂, and the weight of Al, calculated as Al₂O₃, comprised in the framework structure of the zeolitic material comprised in the coating according to (B).

A further preferred embodiment (71) concretizing any one of embodiments (43) to (70) relates to said catalyst, wherein from 95 to 100 weight-%, more preferably from 97 to 100 weight-%, more preferably from 99 to 100 weight-%, of the coating according to (B) consist of the zeolitic material comprised in the coating according to (B), Fe, Cu, O, and the first non-zeolitic oxidic material comprised in the coating according to (B).

A further preferred embodiment (72) concretizing any one of embodiments (43) to (71) relates to said catalyst, wherein the catalyst has a loading of the coating according to (B) in the range of from 1.0 to 5.0 g/in³, more preferably in the range of from 1.75 to 3.75 g/in³, more preferably in the range of from 1.9 to 3.5 g/in³.

A further preferred embodiment (73) concretizing any one of embodiments (43) to (72) relates to said catalyst, wherein from 95 to 100 weight-%, more preferably from 97 to 100 weight-%, more preferably from 99 to 100 weight-%, of the catalyst consist of the substrate according to (A) and the coating according to (B).

Yet further, an embodiment (74) of the present invention relates to a system for the treatment of an exhaust gas of a diesel combustion engine, the system comprising a diesel oxidation catalyst, a catalyzed soot filter, and a catalyst according to any one of embodiments (42) to (73), wherein in said system, the diesel oxidation catalyst is located upstream of the catalyzed soot filter, and wherein the catalyzed soot filter is located upstream of said catalyst according to any one of embodiments (42) to (73).

An preferred embodiment (75) concretizing embodiment (74) relates to said system, wherein the system further comprises a reductant injector, more preferably one or more of a hydrocarbon injector, a hydrocarbon in-cylinder post injector, and a urea injector, wherein the reductant injector is more preferably arranged upstream of the catalyzed soot filter, wherein the reductant injector is more preferably arranged downstream of the diesel oxidation catalyst.

Yet further, an embodiment (76) of the present invention relates to a use of a catalyst of any one of embodiments (42) to (73) or a system of embodiment (74) or (75), for the treatment of an exhaust gas of a diesel combustion engine.

Yet further, an embodiment (77) of the present invention relates to a method for treating an exhaust gas of a diesel combustion engine, said method comprising bringing said exhaust gas in contact with a catalyst according to any one of embodiments (42) to (73).

Yet further, an embodiment (78) of the present invention relates to a method for treating an exhaust gas of a diesel combustion engine, said method comprising passing said exhaust gas through a system according to embodiment (74) or (75).

According to the present invention, it is preferred that a pH value is measured according to the international standard ISO 34-8 (International Standard ISO 34-8: Quantities and Units—Part 8: Physical Chemistry and Molecular Physics, Annex C (normative): pH. International Organization for Standardization, 1992). According to the present invention it is yet further preferred that the pH values as defined in the present application are determined in accordance with ISO 80000-9, Annex C, pH.

In the context of the present invention, the second non-zeolitic oxidic material particularly functions as binder.

In the context of the present invention, the term “the surface of the internal walls” is to be understood as the “naked” or “bare” or “blank” surface of the walls, i.e. the surface of the walls in an untreated state which consists—apart from any unavoidable impurities with which the surface may be contaminated—of the material of the walls.

In the context of the present invention, the term “consists of” with regard to the weight-% of one or more components indicates the weight-% amount of said component(s) based on 100 weight-% of the entity in question. For example, the wording “wherein from 0 to 0.001 weight-% of the first coating consists of X” indicates that among the 100 weight-% of the components of which said coating consists of, 0 to 0.001 weight-% is X.

Furthermore, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

In the context of the present invention, a weight/loading of a non-zeolitic oxidic material is calculated as the weight/loading of the respective non-zeolitic oxidic material as oxide or the sum the weights/loadings of the respective non-zeolitic oxidic material as oxides. For example, if a non-zeolitic oxidic material is silica, the weight of said non-zeolitic oxidic material is calculated as SiO₂. As a further example, if a non-zeolitic oxidic material consists of a mixed oxide comprising Ti and Al, the weight of said non-zeolitic oxidic material is calculated as sum of TiO₂ and Al₂O₃.

The present invention is further illustrated by the following examples and reference examples.

### EXAMPLES

### Reference Example 1: Determination of the Pore Volume

The pore volume was determined by mercury intrusion using mercury porosimetry according to DIN 66133 and ISO 15901-1.

### Reference Example 2: Determination of the Volume-Based Particle Size Distributions

The volume-based particle size distributions, in particular Dv50 and Dv90 values, were determined by a static light scattering method using Sympatec HELOS (3200) & QUIXEL equipment, wherein the optical concentration of the sample was in the range of from 6 to 10%.

### Comparative Example 1: Preparation of a Catalyst Having a Coating Comprising a Cu-Containing Zeolitic Material

Two different slurries, slurry (1) and slurry (2), were prepared separately from each other.

For slurry (1), a copper oxide powder having a Dv50 of 33 micrometers as a source of copper was added to water. The amount of copper oxide was calculated such that the total amount of copper, calculated as CuO, in the coating after calcination was 5.5 weight-% based on the weight of the zeolitic material having framework structure type CHA. The resulting aqueous mixture was milled using a continuous milling apparatus so that the Dv90 value of the particles was about 5.8 micrometers. The resulting slurry had a solid content of 8 weight-% based on the total weight of said slurry. A zirconium acetate solution as a source of an oxidic component was added to the copper oxide-containing aqueous mixture forming a slurry. The amount of zirconium acetate was calculated such that the amount of zirconia in the coating, calculated as ZrO₂, was 5 weight-% based on the weight of the zeolitic material having framework structure type CHA. Water and a zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer) were added to the slurry to form an aqueous mixture having a solid content of about 40 weight-% based on the total weight of said aqueous mixture. The amount of the Cu-containing zeolitic material having framework structure type CHA was calculated such that the loading of the Cu-containing zeolitic material having framework structure type CHA after calcination was 87 weight-% of the loading of the coating in the catalyst after calcination. The resulting slurry was milled using a continuous milling apparatus so that the Dv90 value of the particles was smaller than 10 micrometers.

For slurry (2), an aqueous slurry having a solid content of 41.5 weight-% based on the total weight of said slurry and comprising water and alumina as a non-zeolitic oxidic material (consisting of 80 weight-% Al₂O₃ and 20 weight-% ZrO₂) was prepared. The amount of said zirconia-containing alumina was calculated such that the amount thereof after calcination was 5 weight-% based on the weight of the zeolitic material having framework structure type CHA after calcination.

Subsequently, slurries (1) and (2) were combined to obtain a final slurry. The pH of the final slurry was determined as being 4.6. The solid content of the final slurry was about 40.3 weight-% based on the total weight of the final slurry.

A cylindrical cordierite flow through substrate (having an axial length of 101.6 mm, a diameter of 58 mm) was coated from the inlet end with the final slurry over 100% of the substrate axial length. To this effect, the substrate was dipped in the final slurry diluted to a solid content of 38 weight-% from the inlet end until the slurry reached the top of the substrate. Further, the coated substrate was dried in air at 130° C. for 30 minutes and then calcined in air at 450° C. for 2 hours.

The final coating loading after calcination was about 2 g/in³, including about 1.73 g/in³ of a zeolitic material having framework structure type CHA, 0.09 g/in³ of zirconia-containing alumina, about 0.09 g/in³ of zirconia and 0.095 g/in³ of copper oxide.

### Example 1: Preparation of a Catalyst Having a Coating Comprising a Fe and Cu-Containing Zeolitic Material

A zeolitic material having framework type CHA (a chabazite having a Dv50 of 2.2 micrometers, a Dv90 of 5.2 micrometers, a SiO₂:Al₂O₃ molar ratio of 18, an average crystal size of 0.4 micrometer) was impregnated with a solution of Fe(III) nitrate nonahydrate (Fe(NO₃)₃·9H₂O) and water. The amount of water was chosen so that the solution fills 90% of the pore volume of the zeolitic material and the amount of Fe(III) nitrate nonahydrate was chosen so that the iron oxide loading on the zeolitic material having framework structure type CHA after calcination was 0.2 weight-%. Subsequently, the impregnated zeolitic material was heated in air to 60° C. and held at this temperature for 2 hours, heated to 90° C. and held at this temperature for 1 hour, heated to 130° C. and held at this temperature for 2 hours, and finally heated to 590° C. and held at this temperature for 2 hours.

For preparing a final slurry and a coated substrate, the recipe according to comparative example 1 was followed but the zeolitic material having framework structure type CHA was replaced by the calcined Fe-impregnated zeolitic material having framework structure type CHA. Further, the copper oxide content on the zeolitic material having framework structure type CHA was 4.8 weight-%. The pH of slurry (1) comprising the zeolitic material impregnated with Fe and comprising copper oxide was determined before milling as being 4.1. The pH of the final slurry was determined as being 4.4. The final washcoat loading after calcination was 2.0 g/in³.

### Reference Example 3: Preparation of a Catalyst Having a Coating Comprising a Fe and Cu-Containing Zeolitic Material

Fe(III) nitrate nonahydrate (Fe(NO₃)₃·9H₂O) and Cu acetate monohydrate (CuAc₂·H₂O) were dissolved in water whereby additionally 0.3 weight-% of citric acid were added, calculated based on the total weight of the Cu acetate monohydrate. In a next step, the resulting solution was impregnated on a zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer). The amount of Cu acetate monohydrate and Fe(III) nitrate nonahydrate were chosen so that the final copper oxide loading and iron oxide loading after calcination were 4.8 weight-% and 0.2 weight-%, respectively. The amount of water was chosen so that this solution fills 90% of the pores of the zeolitic material. Subsequently, the resulting impregnated zeolitic material was heated in air to 60° C. and held at this temperature for 2 hours, heated to 130° C. and held at this temperature for 1 hour, and finally heated to 590° C. and held at this temperature for 4 hours. For preparing a final slurry and a coated substrate, the recipe according to comparative example 1 was followed without using the copper oxide slurry. The pH of slurry (1) comprising the zeolitic material impregnated with Fe and comprising copper oxide was determined before milling as being 4. The pH of the final slurry was determined as being 4.4. The final washcoat loading after calcination was 2.0 g/in³.

### Example 2: Catalytic Testing of the Catalysts of Comparative Example 1, Example 1, and Reference Example 3

Catalytic testings were performed using cores having a diameter of 25.4 mm which were drilled out from the prepared coated substrates. Further, the cores were shortened to a length of 76.2 mm. The thus obtained samples were tested in a gas stream comprising 150 ppm NO, 225 ppm NH₃, 80 ppm C₃H₆ (C1 basis) 10% O₂, 5% CO₂ and 5% H₂O. The gas hourly space velocity was set to 60000/h for measurements in the temperature range of from 160 to 500° C. and to 120000/h for measurements at a temperature of 600° C. The results of the catalytic testings are shown in FIGS. 1 and 2.

As shown in FIG. 1, the NOx conversion over the whole temperature range is similar for the catalyst of Example 1 and Reference Example 3 compared to the catalyst of Comparative Example 1. For the temperatures at 160 and 180° C. Example 1 shows the highest NOx conversions. Further, the catalysts of Example 1 and Reference Example 3 both show a strongly reduced high temperature N₂O make compared to Comparative Example 1, as shown in FIG. 2.

### Comparative Example 2: Preparation of a Catalyst Having a Coating Comprising a Cu-Containing Zeolitic Material

Water was impregnated on a zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer) so that the water volume fills 90% of the pores of the zeolitic material having framework structure type CHA. Then, the resulting zeolitic material was calcined in air at 590° C. For preparing a final slurry and a coated substrate, the recipe according to Comparative Example 1 was followed but the zeolitic material having framework structure type CHA was replaced by the calcined zeolitic material having framework structure type CHA. Thus, the copper oxide content on the zeolitic material having framework structure type CHA was 5.5 weight-%. The final washcoat loading after calcination was 2.0 g/in³.

### Example 3: Preparation of a Catalyst Having a Coating Comprising a Fe and Cu-Containing Zeolitic Material

A zeolitic material having framework t structure ype CHA (a chabazite having a Dv50 of 2.2 micrometers, a Dv90 of 5.2 micrometers, a SiO₂:Al₂O₃ molar ratio of 18, and an average crystal size of 0.4 micrometer) was impregnated with a solution of Fe(III) nitrate nonahydrate (Fe(NO₃)₃·9H₂O) and water. The amount of water was chosen so that the solution fills 90% of the pore volume of the zeolitic material having framework structure type CHA and the amount of Fe(III) nitrate nonahydrate was chosen so that the iron oxide loading on the zeolitic material after calcination was 0.3 weight-%. For preparing a final slurry and a coated substrate, the recipe according to Comparative Example 1 was followed but the zeolitic material having framework structure type CHA was replaced by the Fe-impregnated zeolitic material having framework structure type CHA and the copper oxide content on the zeolitic material having framework structure type CHA was 4.8 weight-%. The final washcoat loading after calcination was 2.0 g/in³.

### Examples 4-7: Preparation of Catalysts Having a Coating Comprising a Fe and Cu-Containing Zeolitic Material

A zeolitic material (a chabazite having a Dv50 of 2.2 micrometers, a Dv90 of 5.2 micrometers, a SiO₂:Al₂O₃ molar ratio of 18, and an average crystal size of 0.4 micrometer) was impregnated with a solution of Fe(III) nitrate nonahydrate (Fe(NO₃)₃·9H₂O) and water. The amount of water was chosen so that the solution fills 90% of the pore volume of the zeolitic material having framework structure type CHA. The Fe(III) nitrate nonahydrate (Fe(NO₃)₃·9H₂O) was chosen so that the iron oxide loading on the zeolitic material having framework structure type CHA after calcination was as noted in table 1 below for Examples 4-7. For preparing final slurries and coated substrates, the recipe according to Comparative Example 1 was followed but the zeolitic material having framework structure type CHA was replaced by the Fe-impregnated zeolitic material having framework type CHA. The copper oxide content on the zeolitic material having framework structure type CHA was as noted in table 1 below for Examples 4-7. The pH of slurry (1) comprising the zeolitic material impregnated with Fe and comprising copper oxide was determined for each of Examples 4-7, the respective values are listed in table 2. Also, the pH of the final slurry was determined for each of Examples 4-7. The final washcoat loading after calcination was 2.0 g/in³ for Examples 4-7.

TABLE 1
Overview of the iron oxide and copper oxide
contents of the catalysts of Examples 4-7.

| # | FeOₓ [weight-%] | CuO [weight-%] |
|---|---|---|
| Example 4 | 0.1 | 4.8 |
| Example 5 | 0.3 | 4.8 |
| Example 6 | 0.1 | 5.5 |
| Example 7 | 0.3 | 5.5 |

TABLE 2
Overview of the iron oxide and copper oxide
contents of the catalysts of Examples 4-7.

| # | pH of slurry (1) before milling | pH of final slurry |
|---|---|---|
| Comp. Example 2 | 3.7 | 4.8 |
| Example 3 | 2.5 | 4.1 |
| Example 4 | 3.5 | 4.4 |
| Example 5 | 3.6 | 4.7 |
| Example 6 | 3.7 | 4.1 |
| Example 7 | 3.8 | 4 |

### Example 8: Catalytic Testing of the Catalysts of Comparative Example 2 and Examples 3-7

The catalysts were tested on a Euro 6 engine. In order to do that, the coated catalysts were canned and aged hydrothermally at 800° C. for 16 h. Then the catalysts were placed downsteam of a combination of a DOC and a CSF and tested, whereby emissions measurements were made at 220° C., 575° C. and 630° C. The NOx inlet emissions comprised 470 ppm, 700 ppm, 680 ppm, respectively, and the volume flows were set to 20 m³/h for all temperatures.

FIG. 3 shows that the low temperature NOx conversion is similar for the catalyst of Example 3 compared to the catalyst of Comparative Example 2. The catalysts of Examples 4-5 which are prepared with a copper oxide loading of 4.8 weight-% showed a reduced NOx conversion and the catalysts of Examples 6-7 having a copper oxide loading of 5.5 weight-% showed a NOx conversion similar to the Comparative Example 2. All catalysts of Examples 3-7 showed higher NOx conversions at higher temperatures.

It was surprisingly found that the catalyst of Example 3, thus, prepared without calcining the iron impregnated zeolitic material before further use, showed improved catalytic performance compared to the catalyst of Example 5, which comprised approximately the same contents of iron oxide and copper oxide. Further, it was surprisingly found that a higher copper oxide loading of 5.5 weight-% compared to 4.8 weight-% leads to a higher NOx conversion at low temperatures. The high temperature NOx conversion was improved for the catalysts of Examples 3-7 with the additional Fe impregnation.

Further, the catalytic performance was evaluated with respect to the N₂O emissions which were produced over the SCR. The results are shown in FIG. 4. The catalysts of Examples 3-5 which contained 4.8 weight-% CuO showed strongly reduced N₂O emissions at 575° C. and 630° C. compared to the catalyst of Comparative Example 2. Example 6, produced with 5.5 weight-% copper oxide and 0.1 weight-% FeOₓ showed strongly reduced N₂O emissions as well. Also, the catalyst of Example 7 containing 5.5 weight-% copper oxide and 0.3 weight-% FeOₓ showed a better performance with respect to N₂O emissions than the catalyst of Comparative Example 2.

### Examples 9-12: Preparation of Catalysts Having a Coating Comprising a Fe and Cu-Containing Zeolitic Material

A zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer) was impregnated with a solution of Fe(III) nitrate nonahydrate (Fe(NO₃)₃·9H₂O) and water. The amount of water was chosen so that the solution fills 90% of the pore volume of the zeolitic material having framework structure type CHA and the amount of Fe(III) nitrate nonahydrate was chosen so that the iron oxide loading on the zeolitic material having framework structure type CHA after calcination was as given in table 3 below for Examples 9-12.

For preparing final slurries and coated substrates, the recipe according to Comparative Example 1 was followed but the zeolitic material having framework structure type CHA was replaced by the Fe-impregnated zeolitic material having framework structure type CHA and the copper oxide content on the zeolitic material having framework structure type CHA was as noted in table 4 for the Examples 9-12. The final washcoat loading after calcination was 2.0 g/in³.

TABLE 4
Overview of the iron oxide and copper oxide
contents of the catalysts of Examples 9-12.

| # | FeOₓ [weight-%] | CuO [weight-%] |
|---|---|---|
| Example 9 | 0.3 | 4.8 |
| Example 10 | 0.1 | 5.3 |
| Example 11 | 0.3 | 5.3 |
| Example 12 | 0.5 | 5.3 |

### Example 13: Catalytic Testing of the Catalysts of Examples 9-12 and Comparative Example 2

Examples 9-12 and Comparative Example 2 were tested on a Euro 6 engine. In order to do that, the coated catalysts were canned and aged hydrothermally at 800° C. for 16 h. Then, the catalysts were tested downstream of a combination of a DOC and CSF at temperatures of 200° C., 220° C., 575° C. and 630° C. The NOx inlet emissions were 450 ppm, 480 ppm, 700 ppm, 700 ppm, respectively, and the volume flows were set to 20 m³/h for all temperatures.

The results of the catalytic testing are shown in FIG. 5. It can be gathered that the low temperature NOx conversion is similar for Example 9-12 compared to Comparative Example 2. Further, it can be seen that the high temperature conversion was improved for Examples 9-12.

Further, the catalytic performance was evaluated with respect to the N₂O emissions which were produced over the SCR. The results are shown in FIG. 5. It can be gathered that the N₂O produced over the SCR was strongly reduced for the catalysts of Examples 9-12 compared to Comparative Example 2, especially at higher temperatures.

Further, it can be seen that a comparatively higher copper content of led to higher N₂O emissions whereas an increasing iron oxide content led to N₂O reduction.

### Comparative Example 3: Preparation of a Catalyst Having a Coating Comprising a Cu-Containing Zeolitic Material

For slurry (1), a copper oxide powder (a CuO powder having a Dv50 of 33 micrometers) was added to water. The amount of copper oxide was calculated such that the total amount of copper, calculated as CuO, in the coating after calcination was 5.5 weight-% based on the weight of the zeolitic material having framework structure type CHA. The resulting aqueous mixture was milled using a continuous milling apparatus so that the Dv90 value of the particles was about 5.8 micrometers. The resulting slurry had a solid content of 30 weight-% based on the total weight of the slurry. A zirconium acetate solution as a source of an oxidic component was added to the copper oxide-containing aqueous mixture forming a slurry. The amount of zirconium acetate was calculated such that the amount of zirconia in the coating, calculated as ZrO₂, was 5 weight-% based on the weight of the zeolitic material having framework structure type CHA. Water and a zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer) were added to the slurry to form an aqueous mixture having a solid content of about 42.5 to 45 weight-% based on the total weight of said aqueous mixture. The amount of Cu-containing zeolitic material having framework structure type CHA was calculated such that the loading of the zeolitic material having framework structure type CHA after calcination was 87% of the loading of the coating in the catalyst after calcination. The resulting slurry was milled using a continuous milling apparatus so that the Dv90 value of the particles was smaller than 7 micrometers.

For slurry (2), an aqueous slurry having a solid content of about 42 weight-% based on the total weight of the slurry and comprising water and alumina as a non-zeolitic oxidic material (consisting of 80 weight-% Al₂O₃ and 20 weight-% ZrO₂) was separately prepared. The amount of said zirconia-containing alumina was calculated such that the amount thereof after calcination was 5 weight-% based on the weight of the Cu-containing zeolitic material having framework structure type CHA after calcination.

Subsequently, slurries (1) and (2) were combined, the solid content of the obtained final slurry was about 42 weight-% based on the total weight of the final slurry.

A cylindrical cordierite flow through substrate (having a diameter of 143.8 mm and an axial length of 76.2 mm) was coated from the inlet end with the final slurry over 100% of the substrate axial length. To this effect, the substrate was dipped in the final slurry diluted to a solid content of 38 weight-% from the inlet end until the slurry reached the top of the substrate. Further, the coated substrate was dried in air at 130° C. for 30 minutes and then calcined in air at 590° C. for 2 hours.

The final coating loading after calcination was about 3.37 g/in³, including about 2.92 g/in³ of a zeolitic material having framework structure type CHA, 0.15 g/in³ of zirconia-containing alumina, about 0.15 g/in³ of zirconia and 0.16 g/in³ of copper oxide.

### Example 14: Preparation of a Catalyst Having a Coating Comprising a Fe and Cu-Containing Zeolitic Material

A zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer) was impregnated with a solution of Fe(III) nitrate nonahydrate (Fe(NO₃)₃·9H₂O) and water. The amount of water was chosen so that the solution fills 90% of the pore volume of the zeolitic material having framework structure type CHA and the amount of Fe(III) nitrate nonahydrate was chosen so that the iron oxide loading on the zeolitic material having framework structure type CHA after calcination was 0.2 weight-%. Subsequently, the resulting impregnated zeolitic material having framework structure type CHA was dried, heated in air to a temperature of 590° C. and held for 2 hours at this temperature.

For preparing a final slurry and a coated substrate, the recipe according to Comparative Example 3 was followed but the zeolitic material having framework structure type CHA was replaced by the Fe-impregnated zeolitic material having framework structure type CHA and the copper oxide content on the zeolitic material having framework structure type CHA was 4.8 weight-%. The final washcoat loading after calcination was 2.75 g/in³, including 2.39 g/in³ of zeolitic material having framework structure type CHA, 0.12 g/in³ of zirconia-containing alumina, 0.11 g/in³ of copper oxide, 0.12 g/in³ of zirconia and 0.005 g/in³ of FeOₓ.

### Example 15: Preparation of a Catalyst Having a Coating Comprising a Fe and Cu-Containing Zeolitic Material

A zeolitic material having framework structure type CHA (a chabazite having a Dv50 of 2.2 micrometers, a Dv90 of 5.2 micrometers, a SiO₂:Al₂O₃ molar ratio of 18, and an average crystal size of 0.4 micrometer) was impregnated with a solution of Fe(III) nitrate nonahydrate (Fe(NO₃)₃·9H₂O) and water. The amount of water was chosen so that the solution fills 90% of the pore volume of the zeolitic material having framework structure type CHA and the amount of Fe(III) nitrate nonahydrate was chosen so that the iron oxide loading on the zeolitic material having framework structure type CHA after calcination was 0.3 weight-%.

For preparing a final slurry and a coated substrate, the recipe according to Comparative Example 3 was followed but the zeolitic material having framework structure type CHA was replaced by the Fe-impregnated zeolitic material having framework structure type CHA and that the copper oxide content on the zeolitic material having framework structure type CHA was 4.8 weight-%. The final washcoat loading after calcination was 3.4 g/in³, including 2.95 g/in³ of zeolitic material having framework structure type CHA, 0.15 g/in³ of zirconia-containing alumina, 0.14 g/in³ of copper oxide, 0.15 g/in³ zirconia and 0.009 g/in³ FeOₓ.

### Example 16: Catalytic Testing of the Catalysts of Examples 14-15 and Comparative Example 3

In a first test set, comparative Example 3 and Examples 14-15 were tested on a reactor with respect to their catalytic performance. Catalytic testings were performed using cores having a diameter of 25.4 mm which were drilled out from the prepared coated substrates. Further, the cores were shortened to a length of 76.2 mm. Then, the cores were hydrothermally aged at 800° C. for 16 h. The thus obtained samples were tested in a gas stream comprising 325 ppm NO, 125 ppm NO₂, and 750 ppm NH₃. The gas hourly space velocity was set to 100000/h. The results of the catalytic testings are shown in FIGS. 6, 7, and 8.

FIG. 6 shows that the low temperature NOx conversion was similar for the catalysts of Comparative Example 3 and Example 15, the low temperature conversion for the catalyst of Example 14 was only slightly reduced compared thereto. FIG. 7 shows that the NH₃ slip occurred earlier for Example 14 and Example 15 but the increase of the NOx conversion was steeper for Example 15 compared to Comparative Example 3. The shown NH₃ slip is the NH₃ determined after the SCR at a specific NH₃ inlet feed. The N₂O emissions, shown in FIG. 8, were reduced at temperatures below 300° C. for the catalysts of Examples 14-15 compared to Comparative Example 3.

### Example 17: Catalytic Testing of the Catalysts of Examples 14-15 and Comparative Example 3

In a second test set, catalytic testings were performed on full size catalysts as obtained from the respective examples, thus, where a catalyst comprised a cylindrical substrate having a diameter of 143.8 mm and an axial length of 76.2 mm. The catalysts were hydrothermally aged for 16 h at 800° C. and then canned. The catalysts were tested on a Euro 6 engine in a temperature ramp test. The test procedure is detailed in FIG. 9. As can be seen from the graph shown in FIG. 9, after a filter regeneration, the catalysts were cooled down to a temperature of about 220° C., and prefilled with urea. A strong acceleration than led to a temperature ramp.

The results of the testing are shown in FIG. 10. As can be seen from FIG. 10, the NOx conversion for the catalysts of Example 15 and Comparative Example 3 at a temperature of 220° C. was greater than 90%. Further, the NOx conversion was approximately 100% at a temperature in the range of from 300 to 450° C. for both catalysts. At a temperature of 550° C., the NOx conversion of the catalyst according to Example 15 is strongly enhanced compared to that of the catalyst of Comparative Example 3 and the NH₃ slip occurs slightly earlier. As it can be gathered from FIG. 11, the N₂O slip at a temperature of greater than 450° C. is strongly reduced for the catalyst according to Example 15 compared to that of Comparative Example 3.

### Example 18: Preparation of a Catalyst Having a Coating Comprising a Fe and Cu-Containing Zeolitic Material

The slurries and a coated substrate were prepared according to Example 15 considering the following. The copper oxide content on the zeolitic material having framework structure type CHA was 4.5 weight-% and the iron oxide loading was 0.3 weight-%. The final washcoat loading after calcination was 3.4 g/in³ including 2.96 g/in³ of zeolitic material having framework structure type CHA, 0.15 g/in³ of zirconia-containing alumina, 0.13 g/in³ of copper oxide, 0.15 g/in³ zirconia and 0.009 g/in³ FeOₓ.

### Example 19: Catalytic Testing of the Catalysts of Examples 15, 18 and Comparative Example 3

As samples of the catalysts according to Example 15, 18 and Comparative Example 3 cylindrical cores having a diameter of 143.8 mm (5.66 inch) and an axial length of 76.2 mm (3 inch) were prepared. The samples were hydrothermally aged at 800° C. for 16 h. Then, the samples were tested on an engine bench. At several steady state conditions, urea was dosed: at 210° C. and 260° C. The NOx conversion was measured at 10 ppm NH₃ slip whereas at 600° C. the average NOx conversion at constant slip was measured. The volume flow was set to about 80 m³/h and the NH₃/NOx molar ratio (normalized stoichiometric ratio (NSR)) at 210° C. and at 260° C. was set to 1.5. Said NH₃/NOx molar ratio was calculated based on the assumption that one urea molecule decomposes to two NH₃ molecules at temperatures higher than 200° C. At 600° C. the volume flow was set to 20 m³/h and the NH₃/NOx molar ratio to 1 (grey bars) or 3 (white bars).

The test results are shown in FIGS. 12 and 13. As can be seen from FIG. 12, the low temperature NOx conversion at 210° C. and 260° C. was similar for all of the three tested catalysts. The high temperature NOx conversion was worst for the catalyst of Comparative Example 3. The best results in this regard were achieved for the catalyst of Example 18.

As discussed above with respect to the catalytic testing according to Example, the N₂O slip was strongly reduced for the catalyst of Example 15 compared to that of Comparative Example 3. The catalyst of Example 18 showed a further improved reduction in N₂O Slip.

### BRIEF DESCRIPTION OF FIGURES

FIG. 1: shows the NOx conversion at the maximum NH₃ slip at temperatures of 160° C., 500° C. and 600° C., and the NOx conversion at 10 ppm NH₃ slip at 180° C., for Example 1, Reference Example 3, and Comparative Example 1. The temperature in ° C. is shown on the abscissa and the NOx conversion in % is shown on the ordinate.

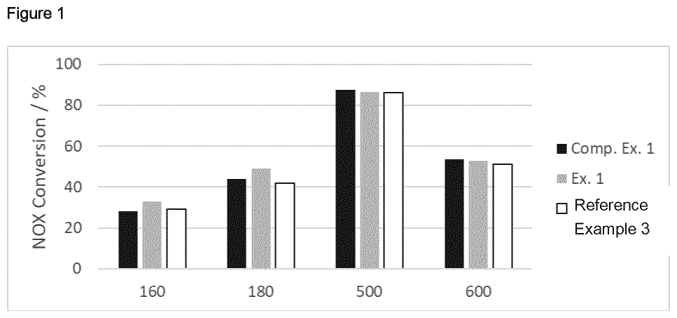

FIG. 2: shows the high temperature N₂O make (designated as N₂O slip in ppm) at 160° C., 180° C., 500° C. and 600° C. for Example 1, Reference Example 3, and Comparative Example 1.

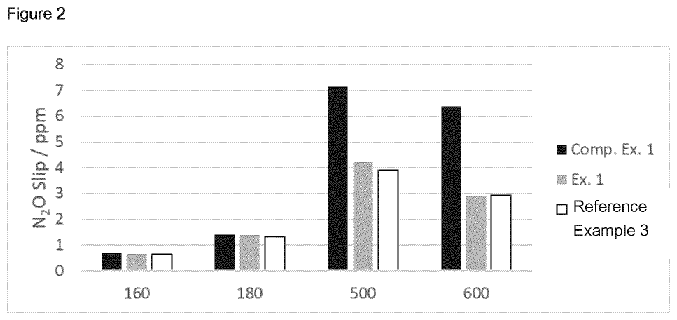

FIG. 3: shows the NOx conversion at temperatures of 220° C., 575° C. and 630° C. for Examples 3-7, and Comparative Example 2. The examples are listed on the abscissa and the NOx conversion in % is shown on the ordinate.

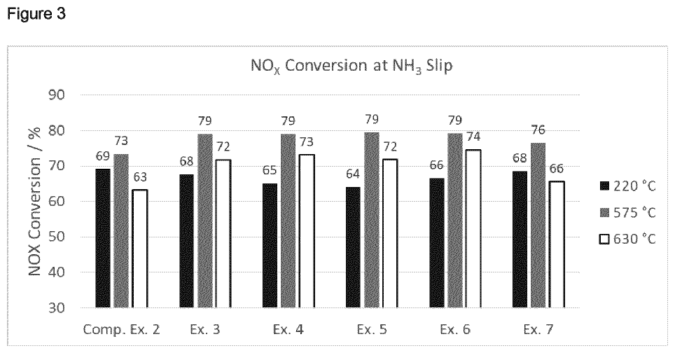

FIG. 4: shows the N₂O emissions at temperatures of 220° C., 575° C. and 630° C. for Examples 3-7, and Comparative Example 2. The examples are listed on the abscissa and the N₂O slip in ppm is shown on the ordinate.

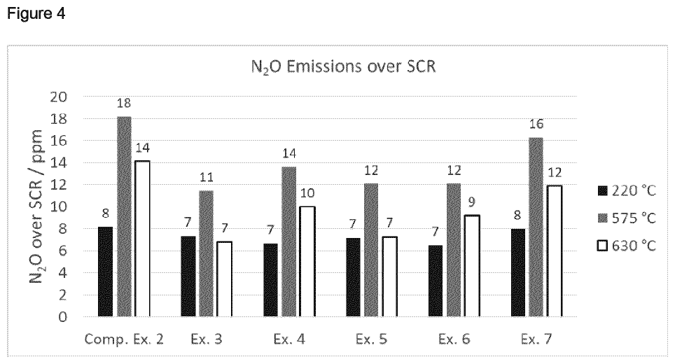

FIG. 5: shows the N₂O emissions at temperatures of 200° C., 220° C., 580° C. and 630° C. for Examples 9-12, and Comparative Example 2. The examples are listed on the abscissa and the N₂O slip in ppm is shown on the ordinate.

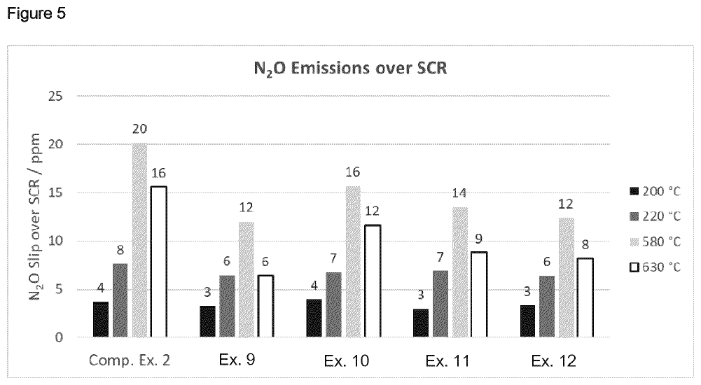

FIG. 6: shows the NOx conversion at NH₃ slip for Examples 14-15 and Comparative Example 3. The temperature in ° C. is shown on the abscissa and the NOx conversion in % is shown on the ordinate.

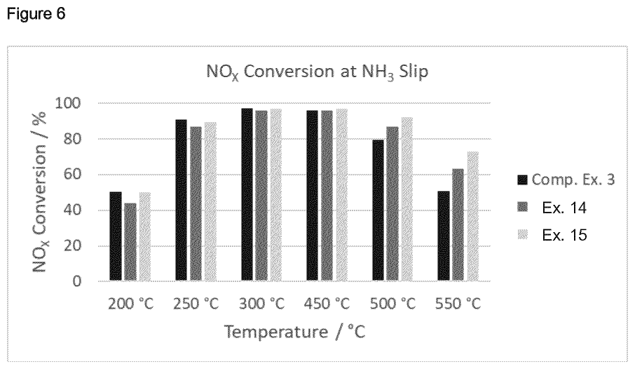

FIG. 7: shows the NOx conversion and the NH₃ slip for Examples 14-15 and Comparative Example 3. The time in s is shown on the abscissa, the NOx conversion in % and the NH₃ slip in ppm is shown on the ordinate.

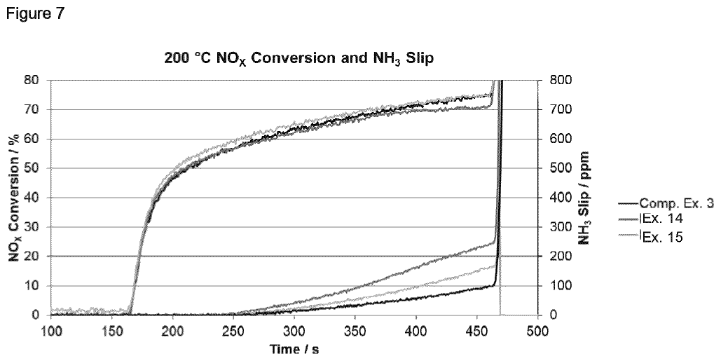

FIG. 8: shows the N₂O slip at maximum NOx conversion for Examples 14-15 and Comparative Example 3. The temperature in ° C. is shown on the abscissa and the N₂O slip in ppm is shown on the ordinate.

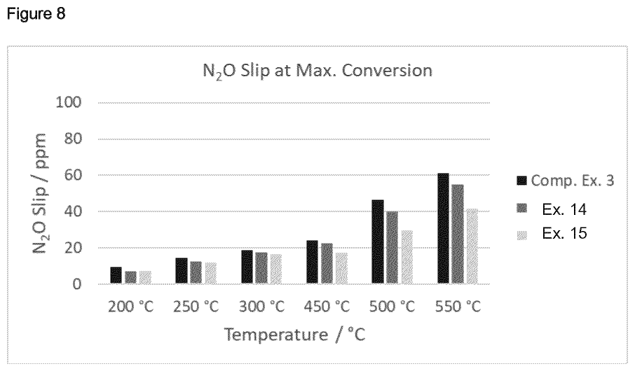

FIG. 9: shows the procedural details for the temperature ramp test. The time in s is shown on the abscissa, the urea inlet in mg/s, the temperature in ° C. and the NOx inlet in ppm are shown on the ordinate.

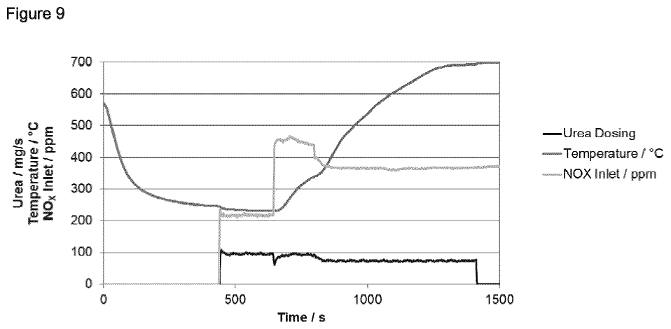

FIG. 10: shows the NOx conversion for the catalysts of Example 15 and Comparative Example 3. The temperature in ° C. is shown on the abscissa, the NOx conversion in % is shown on the left ordinate and the NH₃ slip in ppm is shown on the right ordinate.

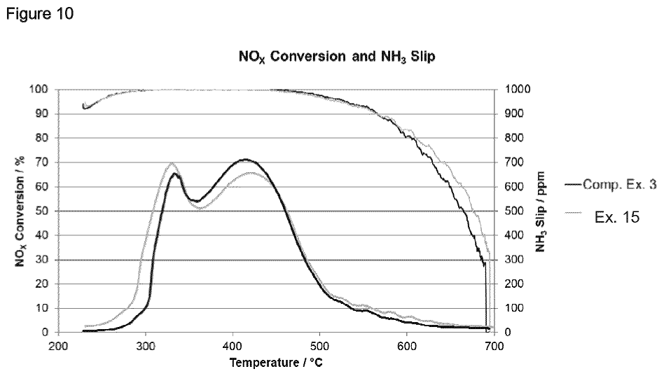

FIG. 11: shows the N₂O slip for the catalysts of Example 15 and Comparative Example 3. The temperature in ° C. is shown on the abscissa and the N₂O slip in ppm is shown on the ordinate.

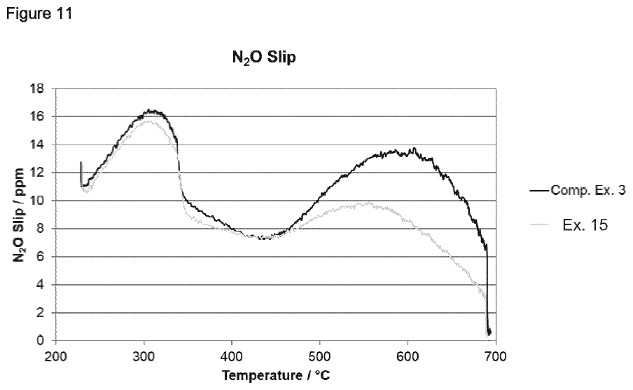

FIG. 12: shows the NOx conversion for the catalysts of Example 15, 18 and Comparative Example 3 at a temperature of 210° C. and a normalized stoichiometric ratio (NSR) of NH₃ to NOx of 1.5, at a temperature of 260° C. and a normalized stoichiometric ratio (NSR) of NH₃ to NOx of 1.5, at a temperature of 600° C. and a normalized stoichiometric ratio (NSR) of NH₃ to NOx of 1, and at a temperature of 600° C. and a normalized stoichiometric ratio (NSR) of NH₃ to NOx of 3. The examples are listed on the abscissa, the NOx conversion in % is shown on the ordinate.

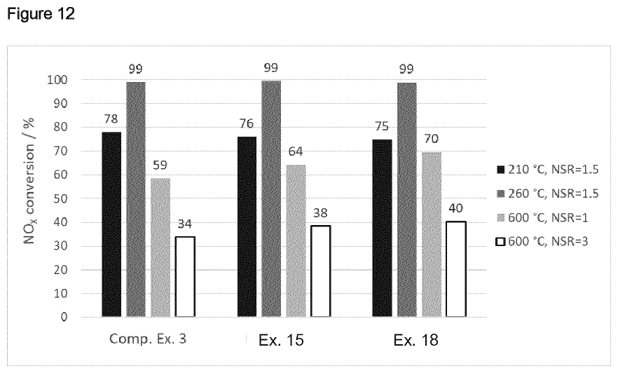

FIG. 13: shows the N₂O slip for the catalysts of Example 15, 18 and Comparative Example 3 at a temperature of 210° C. and a normalized stoichiometric ratio (NSR) of NH₃ to NOx of 1.5, at a temperature of 260° C. and a normalized stoichiometric ratio (NSR) of NH₃ to NOx of 1.5, at a temperature of 600° C. and a normalized stoichiometric ratio (NSR) of NH₃ to NOx of 1, and at a temperature of 600° C. and a normalized stoichiometric ratio (NSR) of NH₃ to NOx of 3. The examples are listed on the abscissa and the N₂O slip in ppm is shown on the ordinate.

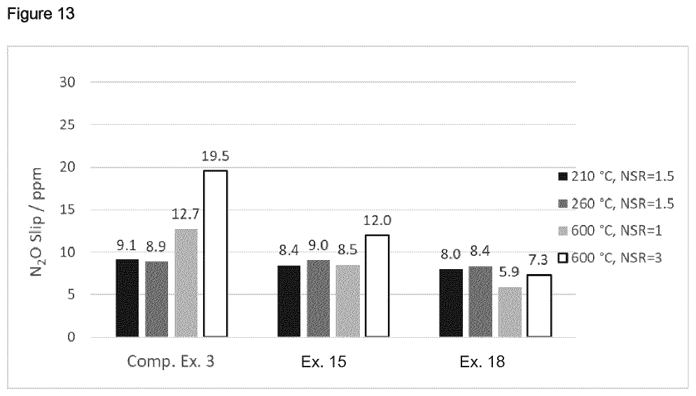

### CITED LITERATURE

US 2015/0290632 A1
CN 104607239 A
WO 2020/063360 A1
WO 2017/134581 A1

1. A process for preparing a catalyst for the treatment of an exhaust gas of a diesel engine, comprising
(i) preparing an aqueous mixture comprising water, a zeolitic material comprising Fe and having a framework structure type selected from the group consisting of CHA, AEI, RTH, LEV, DDR, KFI, ERI, AFX, a mixture of two or more thereof and a mixed type of two or more thereof, wherein the framework structure of the zeolitic material comprises Si, Al and O, the aqueous mixture further comprising a source of Cu and a first non-zeolitic oxidic material selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof,
wherein the aqueous mixture exhibits a weight ratio of Fe comprised in the zeolitic material, calculated as Fe₂O₃, relative to Cu comprised in the copper source, calculated as CuO, Fe₂O₃:CuO, of less than 0.1:1;
(ii) disposing the aqueous mixture obtained in (i) on the surface of the internal walls of a substrate comprising an inlet end, an outlet end, a substrate axial length extending from the inlet end to the outlet end and a plurality of passages defined by internal walls of the substrate extending therethrough, over at least 55% of the substrate axial length;
(iii) subjecting the substrate obtained in (ii) to a heat treatment in a gas atmosphere;
obtaining the catalyst.

2. The process of claim 1, wherein in the framework structure of the zeolitic material according to (i), the molar ratio of Si to Al, calculated as molar ratio of SiO₂:Al₂O₃, is in the range of from 1 to 50.

3. The process of claim 1, wherein the aqueous mixture according to (i) comprises the source of copper at an amount, calculated as CuO, in the range of from 0.025 to 7.5 weight-%, based on the sum of the weight of Si, calculated as SiO₂, and the weight of Al, calculated as Al₂O₃, comprised in the framework structure of the zeolitic material comprised in the aqueous mixture according to (i).

4. The process of claim 1, wherein the zeolitic material according to (i) has a CHA framework structure type.

5. The process of claim 1, wherein the source of copper comprises CuO.

6. The process of claim 1, wherein the zeolitic material according to (i) has a CHA framework structure type and wherein the source of copper comprises CuO.

7. A catalyst for the treatment of an exhaust gas of a diesel combustion engine, obtainable or obtained by a process according to claim 1.

8. A catalyst for the treatment of an exhaust gas of a diesel combustion engine, said catalyst comprising
(A) a substrate comprising an inlet end, an outlet end, a substrate axial length extending from the inlet end to the outlet end and a plurality of passages defined by internal walls of the substrate extending therethrough;
(B) a coating disposed on the surface of the internal walls of the substrate according to (A) over at least 55% of the substrate axial length, the coating comprising a first non-zeolitic oxidic material, Cu, and a zeolitic material comprising Fe and having a framework structure type selected from the group consisting of CHA, AEI, RTH, LEV, DDR, KFI, ERI, AFX, a mixture of two or more thereof and a mixed type of two or more thereof, wherein the framework structure of the zeolitic material comprises Si, Al and O,
wherein the first non-zeolitic oxidic material is selected from the group consisting of alumina, silica, titania, zirconia, ceria, lanthana, praseodymium oxide, manganese oxide, a mixed oxide comprising one or more of Al, Si, Ti, Zr, La, Mn, Pr, and Ce, and a mixture of two or more thereof;
wherein the coating according to (B) exhibits a weight ratio of Fe, calculated as Fe₂O₃, relative to Cu, calculated as CuO, Fe₂O₃:CuO, of less than 0.1:1.

9. The catalyst of claim 8, wherein the zeolitic material comprised in the coating according to (B) has a CHA framework structure type.

10. The catalyst of claim 8, wherein the zeolitic material comprised in the coating according to (B) exhibits a molar ratio of silicon oxide to aluminum oxide, calculated as SiO₂ to Al₂O₃, SiO₂:Al₂O₃, in the range of from 1 to 50.

11. The catalyst of claim 8, wherein the copper comprised in the coating according to (B) is comprised in one or more of the zeolitic material comprised in the coating according to (B) and the first non-zeolitic oxidic material comprised in the coating according to (B).

12. The catalyst of claim 8, wherein the zeolitic material comprised in the coating according to (B) comprises Fe in an amount, calculated as Fe₂O₃, in the range of from 0.05 to 2 weight-%, based on the sum of the weight of Si, calculated as SiO₂, and the weight of Al, calculated as Al₂O₃, comprised in the framework structure of the zeolitic material comprised in the coating according to (B).

13. The catalyst of claim 8, comprising the first non-zeolitic oxidic material comprised in the coating according to (B) at an amount in the range of from greater than 0 to 20 weight-%, based on the sum of the weight of Si, calculated as SiO₂, and the weight of Al, calculated as Al₂O₃, comprised in the framework structure of the zeolitic material comprised in the coating according to (B).

14. The catalyst of claim 8, wherein the zeolitic material comprised in the coating according to (B) is disposed on the surface of the internal walls of the substrate according to (A) at a loading in the range of from 1.00 to 4.50 g/in³.

15. The catalyst of claim 8, having a Fe loading, calculated as Fe₂O₃, in the range of from 0.001 to 0.030 g/in³.

16. The catalyst claim 8, having a Cu loading, calculated as CuO, in the range of from 0.08 to 0.18 g/in³.

17. The catalyst of claim 8, having a loading of the coating according to (B) in the range of from 1.0 to 5.0 g/in³.

18. A system for the treatment of an exhaust gas of a diesel combustion engine, the system comprising a diesel oxidation catalyst, a catalyzed soot filter, and a catalyst according to claim 8, wherein in said system, the diesel oxidation catalyst is located upstream of the catalyzed soot filter, and wherein the catalyzed soot filter is located upstream of said catalyst according to claim 8.

19. A method of treating an exhaust gas of a diesel combustion engine, said method comprising bringing said exhaust gas in contact with a catalyst according to claim 8.

20. A method of treating an exhaust gas of a diesel combustion engine, said method comprising passing said exhaust gas through a system according to claim 18.
